(19) United States
(12) Patent Application Publication
(10) Pub. No.: US 2026/0192271 A1
(43) Pub. Date: Jul. 9, 2026

(54) METHOD TO PROTECT CATALYST IN A CATALYST-CONTAINING STRUCTURE FOR REMOVAL FROM A REACTOR

(71) Applicant: SAUDI ARABIAN OIL COMPANY, Dhahran (SA)

(72) Inventors: Omer Refa Koseoglu, lstanbul (TR); Stanley C. Gustas, III, Houston, TX (US); Rakan Battat, AI-Khobar (SA)

(73) Assignee: SAUDI ARABIAN OIL COMPANY, Dhahran (SA)

(21) Appl. No.: 19/009,170

(22) Filed: Jan. 3, 2025

(51) Int. Cl. B01J 8/00; B01J 8/18; B01J 33/00; G01N 31/10

(52) U.S. Cl. CPC B01J 8/0035; B01J 8/1809; B01J 8/1827; B01J 33/00; G01N 31/10; B01J 2208/00008; B01J 2208/00761; B01J 2208/00814

(57) ABSTRACT

Methods for removal of catalyst-containing structures are provided, wherein the catalyst-containing structures were deployed in a reactor and the catalyst therein has been subject to reaction. The catalyst-containing structures are encapsulated in a C31-C50 paraffin, in certain embodiments a mixture of two or more C31-C50 paraffins, optionally together with one or more light paraffins. The methods facilitate safe handling and transport thereof.

### RELATED APPLICATIONS

Not applicable.

### BACKGROUND OF THE INVENTION

### Field of the Invention

The present invention relates to catalyst-containing structures such as catalyst reactor baskets.

### Description of Related Art

Catalyst-containing structures such as catalyst baskets for reactor systems are known in various documents, including, among others, U.S. Ser. No. 11/071,959B1, U.S. D887,578S, U.S. D847,371S, U.S. Pat. No. 9,802,173B1, U.S. Pat. No. 9,463,427B1, and U.S. D768,844S, each of which is incorporated by reference in their entireties. The specific designs and features of the catalyst baskets described in these documents can best be appreciated by a review of their respective disclosures.

A problem encountered in the use of catalyst-containing structures relates to removal of catalysts baskets. For example, in certain hydroprocessing reactions the catalyst particles therein are typically coked, contain wash oil, and/or contain other contaminants such as hydrogen sulfide. Such particles may be susceptible to exothermic autothermal reactions, and thus removal and transport of spent catalysts baskets poses risk.

There remains a need in the art for improvements related to handling of catalyst-containing structures.

### SUMMARY

Provided herein are methods of use of catalyst-containing structures with improved safety.

In certain embodiments, methods of removal of a catalyst-containing structure having spent or contaminated catalyst from a reactor are provided. The removal occurs while maintaining the reactor under a nitrogen blanket. A receptacle dimensioned and configured to hold the catalyst-containing structure is introduced for full submersion via a head space of the reactor. The receptacle is positioned about the catalyst-containing structure. The receptacle either (a) contains an amount of encapsulating material, in the form of a liquified encapsulating material or a liquified encapsulating material solution, that is sufficient to submerge the catalyst-containing structure, and the receptacle containing the catalyst-containing structure and the encapsulating material is removed as a loaded receptacle; or (b) contains an amount of encapsulating material, in the form of a liquified encapsulating material or a liquified encapsulating material solution, that is less than sufficient to submerge the catalyst-containing structure, additional encapsulating material is added while the under the nitrogen blanket to submerge the catalyst-containing structure, and the receptacle containing the catalyst-containing structure and the encapsulating material is removed as a loaded receptacle.

In certain embodiments the herein methods further comprise adding a lid to the loaded receptacle either within the reactor and while under the nitrogen blanket, or outside of the reactor.

In certain embodiments the herein methods further comprise solidifying the liquified encapsulating material or the liquified encapsulating material solution either within the reactor and while under the nitrogen blanket, or outside of the reactor. In certain embodiments the herein methods further comprise solidifying the liquified encapsulating material or the liquified encapsulating material solution either within the reactor and while under the nitrogen blanket, or outside of the reactor, and removing from the receptacle an encapsulated catalyst-containing structure.

In certain embodiments of the herein methods the encapsulating material initially in the receptacle comprises liquified encapsulating material, and wherein solidifying comprises exposing the receptacle with the catalyst-containing structure including spent and/or contaminated catalyst particles having liquified encapsulating material to temperatures below the melting point of the encapsulating material.

In certain embodiments of the herein methods the encapsulating material initially in the receptacle comprises liquified encapsulating material, and wherein solidifying comprises exposing the receptacle with the catalyst-containing structure including spent and/or contaminated catalyst particles having liquified encapsulating material to a temperature in the range of about −20 to about 25° C. or about −20 to about 25° C.

In certain embodiments of the herein methods the encapsulating material initially in the receptacle comprises liquified encapsulating material solution comprising the encapsulating material and a solvent, and wherein solidifying comprises evaporation of the solvent.

In certain embodiments of the methods herein, the encapsulating material comprises a C31-C50 paraffin, and in additional embodiments of the methods herein the encapsulating material comprises a mixture of two or more C31-C50 paraffins; in some of these embodiments at least a major amount of heavy paraffins comprise n-paraffins.

In certain embodiments of the methods herein, the encapsulating material comprises a mixture containing one or more heavy paraffins including C31-C50 paraffins, and a light paraffinic component including one or more paraffins having lower carbon numbers. In some embodiments, the light paraffinic component comprises one or more C15-C30, C16-C30, C17-C30, C18-C30 or C19-C30 paraffins. In certain of these embodiments, at least a portion of the paraffins in the heavy paraffinic component comprise n-paraffins, and at least a portion of the paraffins having lower carbon numbers comprise n-paraffins; at least a major amount, a significant amount or a substantial amount of the paraffins in the heavy paraffinic component comprise n-paraffins, and at least a portion of the paraffins having lower carbon numbers comprise n-paraffins; or at least a portion of the paraffins in the heavy paraffinic component comprise n-paraffins, and at least a major amount, a significant amount or a substantial amount of the paraffins having lower carbon numbers comprise n-paraffins.

The herein methods of removal of a catalyst-containing structure having spent or contaminated catalyst from a reactor may be carried out using a catalyst-containing structure described herein, including embodiments in which the initial catalyst-containing structure is an encapsulated catalyst-containing structure.

In certain embodiments herein, methods of testing a catalyst in a reactor are provided comprising: inserting an encapsulated catalyst-containing structure in a reactor together with principal catalyst, the encapsulated catalyst-containing structure comprising a containment structure having catalyst particles contained within the catalyst-containing structure, the containment structure configured and dimensioned for insertion within a reactor and configured and dimensioned to fit in a minor volume of the reactor, the containment structure having external surfaces, wherein all or a portion of the external surfaces are permeable external surfaces having a plurality of openings permitting fluids to pass through while providing a barrier to retain catalyst particles, wherein the catalyst particles are dimensioned greater than a dimension of the openings, and wherein at least the permeable external surfaces are encapsulated in a coating material comprising heavy paraffins including C31-C50 paraffins; removing the coating material from the encapsulated catalyst-containing structure; flowing a reactant fluid in the reactor through the principal catalyst and through the catalyst-containing structure having the coating material removed and with the catalyst particles for testing contained within the catalyst-containing structure and exposed to reactant fluid flowing in the reactor; and removing the catalyst-containing structure according to the methods herein including, for example, use of a receptacle containing the catalyst-containing structure and the encapsulating material.

In certain embodiments herein, methods of catalyzing a reactant fluid are provided comprising: inserting an encapsulated catalyst-containing structure in a reactor together with principal catalyst, the encapsulated catalyst-containing structure comprising a containment structure having catalyst particles contained within the catalyst-containing structure, the containment structure configured and dimensioned for insertion within a reactor, the containment structure having external surfaces, wherein all or a portion of the external surfaces are permeable external surfaces having a plurality of openings permitting fluids to pass through while providing a barrier to retain catalyst particles, wherein the catalyst particles are dimensioned greater than a dimension of the openings, and wherein at least the permeable external surfaces are encapsulated in a coating material comprising heavy paraffins including C31-C50 paraffins; removing the coating material from the encapsulated catalyst-containing structure; flowing the reactant fluid in the reactor through the principal catalyst and through the catalyst-containing structure having the coating material removed and with the catalyst particles contained within the catalyst-containing structure; and removing the catalyst-containing structure according to the methods herein including, for example, use of a receptacle containing the catalyst-containing structure and the encapsulating material.

In certain embodiments of the herein methods, the permeable external surfaces comprise a plurality of apertures and wherein the catalyst particles contained within the catalyst-containing structure have dimensions greater than that of the apertures. In certain implementations the permeable external surfaces comprise wire mesh. In certain implementations the wire mesh comprises a wire diameter of about 0.1-0.7 millimeters and polygonal apertures having sides of about 0.5-3.0 millimeters. In certain implementations catalyst particles contained within the catalyst-containing structure have a dimension that is larger than the size of the polygonal openings of the wire mesh. In certain implementations polygonal openings are quadrilateral. In certain implementations the polygonal openings are squares with sides of about 1.2-1.6 millimeters.

In certain embodiments of the herein methods, the catalyst-containing structure comprise one or more chambers as separate layers along the axial direction, one or more compartments separated radially, or both one or more chambers as separate layers along the axial direction and one or more compartments separated radially.

In certain embodiments of the herein methods, the coating material comprises a C31-C50 paraffin. In certain embodiments of the herein methods, the coating material comprises a mixture of two or more C31-C50 paraffins. In these embodiments at least a major amount of heavy paraffins comprise n-paraffins.

In certain embodiments of the herein methods, the coating material comprises a mixture containing one or more heavy paraffins including C31-C50 paraffins, and a light paraffinic component including one or more paraffins having lower carbon numbers. In certain implementations the light paraffinic component comprises one or more C15-C30, C16-C30, C17-C30, C18-C30 or C19-C30 paraffins. In these embodiments and implementations: at least a portion of the paraffins in the heavy paraffinic component comprise n-paraffins, and at least a portion of the paraffins having lower carbon numbers comprise n-paraffins; at least a major amount, a significant amount or a substantial amount of the paraffins in the heavy paraffinic component comprise n-paraffins, and at least a portion of the paraffins having lower carbon numbers comprise n-paraffins; or at least a portion of the paraffins in the heavy paraffinic component comprise n-paraffins, and at least a major amount, a significant amount or a substantial amount of the paraffins having lower carbon numbers comprise n-paraffins.

In some embodiments of the herein methods, removing the coating material from the encapsulated catalyst-containing structure is in situ removal and comprises stripping during startup by melting the coating material from the catalyst-containing structure at a temperature above that of the coating material. In some embodiments herein the methods further comprise: removing a first portion of the coating material ex situ; and inserting the encapsulated catalyst-containing structure having the first portion of the coating material removed and a second portion of the coating material remaining thereon in the reactor; wherein removing the coating material from the encapsulated catalyst-containing structure in situ comprises removing the second portion of the coating material. In some embodiments herein the methods further comprise: removing all or a portion of the coating material from the encapsulated catalyst-containing structure ex situ; inserting the catalyst-containing structure having all or a portion of the coating material removed in a reactor together with principal catalyst; and flowing the reactant fluid in the reactor through the principal catalyst and through the catalyst-containing structure having the coating material removed and with the catalyst particles contained within the catalyst-containing structure; in some implementations wherein a first portion of the coating material is that which is removed ex situ, and wherein inserting the catalyst-containing structure comprises inserting the encapsulated catalyst-containing structure having the first portion of the coating material removed and a second portion the coating material remaining thereon in the reactor, the method further comprising removing the second portion of the coating material in situ before flowing the reactant fluid, wherein removal in situ comprises stripping during startup by melting the coating material from the catalyst-containing structure at a temperature above that of the coating material. In certain embodiments herein including in situ removal, wherein melted liquid coating material forms additional reactants. In certain embodiments herein ex situ removal comprises stripping during startup by melting all or a portion of the coating material from the catalyst-containing structure at a temperature above that of the coating material and/or by mechanically removing all or a portion of the coating material from the catalyst-containing structure; in some implementations coating material removed ex situ is integrated with the fluid flowing in the reactor, or is reused as coating material.

In some embodiments of the herein methods, the catalyst-containing structure comprises a minor portion of catalyst for reaction of fluids in the reactor, and wherein the reactor contains a major, significant or substantial amount of principal catalyst for reaction with the fluids that is separate from the catalyst in the catalyst-containing structure.

In some embodiments of the methods further comprise flowing hydrogen together with the reactant fluid. In certain embodiments of the methods herein, the wherein the catalysts in the catalyst-containing structure comprise hydroprocessing catalysts having hydrodesulfurization (HDS) functionality, hydrodenitrogenation (HDN) functionality, hydrodemetallization (HDM) functionality, hydrocracking (HCR) functionality, hydrogenation (HYD) functionality, or a combination thereof.

In certain embodiments the catalyst comprises a porous support and at least one metal supported on the porous support. In certain embodiments the porous support comprises active support materials including a zeolite, and a binder material which is inactive or less active than the zeolite, wherein the binder comprises one or more of alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, or silica-alumina-zirconia. In certain embodiments the metal comprises an active metal or active metal component(s) carried on the catalyst particles, said active metal or active metal component(s) comprise metals, metal oxides and/or metal sulfides of IUPAC Groups 6, 9 and 10 metals. In certain embodiments the reactant fluid comprises one or more hydrocarbon feedstocks, for example one or more crude oil fractions such as one or more of naphtha, diesel, vacuum gas oil or vacuum residue, and/or one or more intermediate refinery streams such as one or more of deasphalted oil, coker naphtha, coker gas oil, fluid catalytic cracking naphtha or fluid catalytic cracking cycle oils.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various example implementations of this disclosure will be described in detail, with reference to the figures.

FIG. 1 is an overview of a method of making a removable encapsulated catalyst-containing structure according to an embodiment.

FIG. 2 is an overview of a method of making a removable encapsulated catalyst-containing structure according to another embodiment.

FIG. 3 is an overview of a method of making a removable encapsulated catalyst-containing structure according to a further embodiment.

FIG. 4A is an overview of use of an encapsulated catalyst-containing structure in a reactor according to an embodiment.

FIG. 4B is an overview of use of an encapsulated catalyst-containing structure according to embodiments.

FIG. 5 is an overview of removal of a spent catalyst-containing structure according to an embodiment.

### DETAILED DESCRIPTION

Provided herein are methods for removal of catalyst-containing structures that were deployed in a reactor, which are spent and/or contain contaminants, wherein the catalyst therein has been subject to reaction, and handling and transport thereof. Accordingly, the catalyst-containing structures are safeguarded after retrieval, preventing exposure to the environment of the accumulated contaminants therein. In certain embodiments, the methods further comprise recovery of catalyst therein for accompanying testing.

As noted herein, catalyst baskets for reactor systems including having differing designs are known in various documents, including, among others, U.S. Ser. No. 11/071,959B1, U.S. D887,578S, U.S. D847,371S, U.S. Pat. No. 9,802,173B1, U.S. Pat. No. 9,463,427B1, and U.S. D768,844S, each of which is incorporated by reference in their entireties.

In certain implementations of the present disclosure, a catalyst-containing structure such as catalyst-containing structure 102, 202 or 302 described herein is provided that is sized and shaped to insert within a reactor and to receive an amount of catalyst material (“contained catalyst”), with all or a portion of the external surface(s) thereof having sufficient permeability to permit fluid flow from outside of the catalyst-containing structures to contact the contained catalyst for catalytic reaction and to permit fluid flow from the inside of the catalyst-containing structures and continue flow within the reactor in which the catalyst-containing structures is installed. According to the methods herein, these catalyst-containing structures (e.g., catalyst-containing structures 102, 202 and 302) are formed into encapsulated catalyst-containing structures (e.g., encapsulated catalyst-containing structures 150, 250 and 350). The encapsulated catalyst-containing structures are formed by a applying a coating material comprising paraffin wax to cover at least all permeable surfaces of the catalyst-containing structures, preventing air and water from contacting the catalyst particles therein. Accordingly, the encapsulated catalyst-containing structures are stored and transported in a protected state. In certain embodiments one or more encapsulated catalyst-containing structures and inserted a reactor in that protected state.

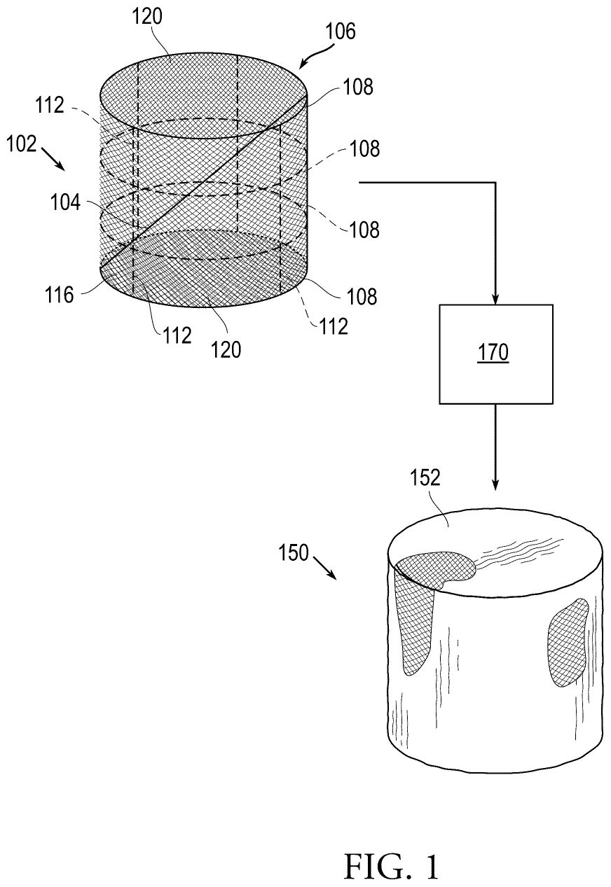

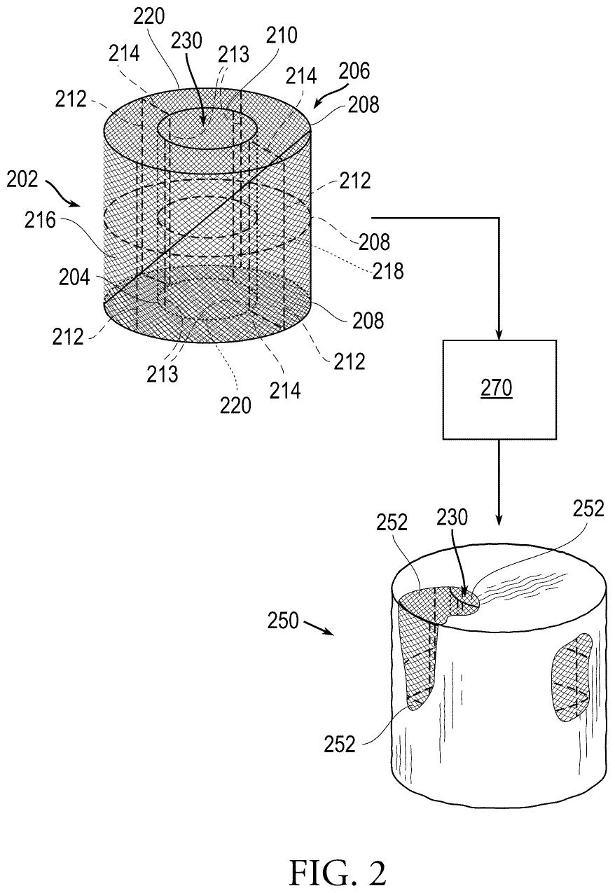

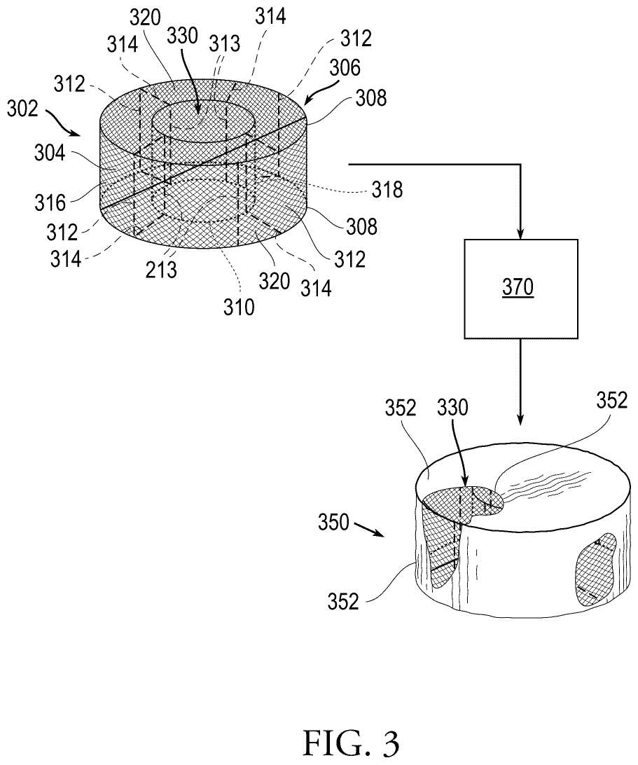

In certain implementations, operation of a reactor with the encapsulated catalyst-containing structures results in melting of the coating material and exposure of the contained catalyst within the catalyst-containing structures. After insertion or installation in a reactor, in situ removal of coating material occurs upon application of heat (e.g., one or more of start-up operations, catalyst pre-treating or pre-activation such as pre-sulfiding, and/or reaction of feedstocks such as hydroprocessing a hydrocarbon feedstock in the presence of hydrogen). The molten coating material may react, for example, by cracking and/or isomerization depending on the reaction conditions and selected catalyst, to expose the contained catalyst during use. Encapsulated catalyst structures 150, 250 and 350 are formed herein by an encapsulating step 170, 270 and 370, respectively, represented in FIG. 1, FIG. 2 and FIG. 3, respectively.

In certain implementations of the present disclosure, an encapsulated catalyst-containing structure (e.g., encapsulated catalyst-containing structure 150, 250 or 350), is formed from a catalyst-containing structure (e.g., catalyst-containing structure 102, 202 or 302) is provided that includes one or more interior compartments (for example, 2-20, 2-10, 2-6, 4-20, 4-10 or 4-6 compartments) that are sized and shaped to receive an portion of the total catalyst within the catalyst-containing structure. In certain embodiments dividers are positioned generally vertically, or in the embodiments of cylindrical catalyst-containing structures along the cylinder axis, so that compartments are separated from each other by fluid-permeable material for example, as shown and described in U.S. Pat. No. 9,463,427B1, U.S. D768,844S and U.S. Pat. No. 9,802,173B1, to form interior compartments. In certain embodiments dividers are positioned to form a plurality of layers arranged axially so that compartments are separated from each other by fluid-permeable material, such as shown and described in U.S. Ser. No. 11/071,959B1.

In certain embodiments an encapsulated catalyst-containing structure (e.g., encapsulated catalyst-containing structure 150, 250 or 350) is configured and dimensioned to fit in a minor volume of the reactor, wherein the catalyst-containing structure accommodates an amount of contained catalyst that is effective for testing the performance thereof, and represents a minor portion relative to the principal catalyst in the reactor separate from that in the catalyst-containing structure, and wherein the reactor contains the principal catalyst, and the amount of the principal catalyst represents a major amount, a significant amount or a substantial amount of requisite catalyst for the reactor. For example, a minor volume of the reactor can include from about 0.1, 1 or 5% up to about 50% of the volume of the reactor, including about 0.1-50, 1-50, 5-50, 10-50, 0.1-25, 1-25, 5-25, 10-25, 0.1-10, 1-10 or 5-10% of the volume of the reactor.

In certain embodiments an encapsulated catalyst-containing structure (e.g., encapsulated catalyst-containing structure 150, 250 or 350) is configured and dimensioned to fit in a minor volume of an individual bed of a reactor, wherein the catalyst-containing structure accommodates an amount of contained catalyst that is effective for testing the performance thereof within that bed, and represents a minor portion relative to the principal catalyst in that reactor bed separate from that in the catalyst-containing structure, and wherein that reactor bed contains principal catalyst for that reactor bed catalyst, and the amount of principal catalyst for that reactor bed represents a major amount, a significant amount or a substantial amount of requisite catalyst for that reactor bed. For example, a minor volume of the reactor bed can include from about 0.1, 1 or 5% up to about 50% of the volume of the reactor bed, including about 0.1-50, 1-50, 5-50, 10-50, 0.1-25, 1-25, 5-25, 10-25, 0.1-10, 1-10 or 5-10% of the volume of the reactor bed.

Various implementations of the shape and dimensional relationships of shape of the encapsulated catalyst-containing structure 150, 250 or 350 and underlying catalyst-containing structure 102, 202 or 302 in FIG. 1, FIG. 2 and FIG. 3, respectively, whereby: FIG. 1 shows an embodiment of a catalyst-containing structure 102 as a cylindrical structure with a relatively high height to diameter ratio; FIG. 2 shows an embodiment of a catalyst-containing structure 202 as an annular structure with a relatively high height to diameter ratio; and FIG. 3 shows an embodiment a catalyst-containing structure 302 as an annular structure with a relatively high diameter to height ratio.

FIG. 1 schematically shows a method of making a removable encapsulated catalyst-containing structure 150, starting with a removable catalyst-containing structure 102 containing catalyst particles in an interior volume 104 (particles not shown for clarity), by encapsulating 170 with a coating material 152, according to an embodiment of the present disclosure. The removable catalyst-containing structure 102 generally comprises a containment structure configured and dimensioned for insertion or installation within a reactor and generally has external surfaces. Catalyst particles are contained within the interior volume 104 of the catalyst-containing structure 102. All or a portion of the external surface(s) are permeable, in the absence of the coating material, with a plurality of openings permitting fluids to pass through while providing a barrier to retain catalyst particles. The catalyst particles are dimensioned greater than a dimension of the openings. The containment structure is encapsulated in a coating material, for example, comprising heavy paraffins such as C31-C50 paraffins. This advantageously prevents air and/or water from contacting the catalyst particles therein.

In the embodiment of FIG. 1 the encapsulated structure 150 (and the underlying structure 102) is generally cylindrical in shape with an equivalent or relatively high height to diameter ratio, for example in the range of about 1:1-50:1, 1:1-25:1, 1:1-10:1, 2:1-50:1, 2:1-25:1 or 2:1-10:1.

The catalyst-containing structure 102 generally comprises a containment structure configured and dimensioned for insertion or installation within a reactor and generally has external surfaces including region(s) of permeability of access to catalyst within. As shown in the example embodiment of FIG. 1, the catalyst-containing structure 102 generally includes a support frame 106 surrounded by external surfaces including an outer wall 116 and end covers 120. The components of the support frame 106 can be formed from a suitable material such as tubular or solid metal bars. In one embodiment the support frame 106 generally includes rings 108 which are positioned at and form the outer circumference of the structure 102, and optional supports 112. In certain embodiments the structure 102 can include rings 108 attached to the outer wall 116 and end covers 120, without supports 112, using sufficiently rigid permeable material as the outer wall 116 and/or end covers 120 to impart strength. Rings 108 are provided at the ends of the support frame 106, and optionally one or more may be provided medially (as shown in dashed lines in FIG. 1). In certain embodiments, rings 108 are linked by supports 112 (shown generally vertical in orientation in FIG. 1) to form the support frame 106. The structure 102 is enclosed by the outer wall 116 and end covers 120. One or both of the end covers 120 may be removable covers (not shown), which may be removably secured by crimp, pins, or other structure to lock the cover in place and prevent detachment during insertion or installation and/or use. The covers 120 are structurally supported by the rings 108 at the ends of the support frame 106 which extend around outer circumferential peripheries and provide structural rigidity to the cover. The frame 106 can also optionally include one or more hooks (not shown) connected to the frame of the basket, to support the structure 102 and couple it to the internals of the reactor. The hooks can also be used to support the structure 102 during loading and unloading of the catalyst at the end of the reactor cycle.

One of both covers 120 can be removed to facilitate filling the compartments with catalyst material. In certain embodiments, clips can be provided on the sides of the basket for selectively attaching the covers to the ends of the basket. For example, the clips can be detached, and the cover removed to expose the interior volume, which in certain embodiments can be separated from other interior volume(s) within the interior, for example separated by dividing walls which permits multi-stage reaction in a single pass of the fluid in the axial direction. Various catalyst materials can be added to the exposed compartments and the cover can be re-secured using the clips. In embodiments in which there are middle layers, the catalyst material is added, the dividing wall added, and additional catalyst material added (optionally different the catalyst material from that of the prior layer). In certain embodiments the structure 102 can be flipped so that a cover 120 on the opposite side can be removed to expose an interior volume from that opposite end, catalyst materials added to the exposed interior volume, resecuring that cover.

In certain example implementations, prior to encapsulating 170, and after removal of coating material 152 from the encapsulated catalyst-containing structure 150, all or a portion of the outer wall 116, and in certain embodiments all or a portion of one or both covers 120, are permeable; accordingly, in operation, liquid material flows through in either direction through the wall and optionally one or both of the covers, while providing a barrier to solid materials of a diameter greater than the diameter of the apertures for permeability, e.g., mesh size in the case of wire mesh, including the catalyst contained in the interior volume 104 (or any portion of the catalyst not subject to attrition).

In certain example implementations, prior to an encapsulating step 170, and after removal of coating material 152 from the encapsulated catalyst-containing structure 150, all or a portion of the outer wall 116 is permeable, and fluid feedstocks and optionally other reactants such as hydrogen gas in a refinery operation can be received from upstream in the reactor and pass through the outer wall 116, that is, into the interior of the structure 102 through the outer wall 116 for contact with the catalyst contained in the interior volume 104 for reaction, and reacted fluids are discharged to the exterior of the structure 102 through the outer wall 116.

In certain example implementations, prior to an encapsulating step 170, and after removal of coating material 152 from the encapsulated catalyst-containing structure 150, all or a portion of the outer wall 116 and all or a portion of the cover 120 that is upstream of flow of fluid are permeable, and fluid feedstocks and optionally other reactants such as hydrogen gas in a refinery operation can be received from upstream in the reactor and pass through the outer wall 116 and the permeable cover 120, that is, into the interior of the structure 102 through the outer wall 116 and permeable cover 120 for contact with the catalyst contained in the interior volume 104 for reaction, and reacted fluids are discharged to the exterior of the structure 102 through the outer wall 116 (optionally with a portion backflowing though the permeable cover 120).

In example implementations, prior to an encapsulating step 170, and after removal of coating material 152 from the encapsulated catalyst-containing structure 150, all or a portion of the outer wall 116 and all or a portion of the cover 120 that is downstream of flow of fluid are permeable, and fluid feedstocks and optionally other reactants such as hydrogen gas in a refinery operation can be received from upstream in the reactor and pass through the outer wall 116 and the permeable cover 120, that is, into the interior of the structure 102 through the outer wall 116 (optionally with a portion backflowing through the permeable cover 120) for contact with the catalyst contained in the interior volume 104 for reaction, and reacted fluids are discharged to the exterior of the structure 102 through the outer wall 116 and the permeable cover 120.

FIG. 2 schematically shows a method of making a removable encapsulated catalyst-containing structure 250, starting with a removable catalyst-containing structure 202 containing catalyst particles in the interior volume 204 thereof, by encapsulating 270 with a coating material 252 according to an embodiment of the present disclosure. In the embodiment of FIG. 2 the encapsulated structure 250 (and the underlying structure 202) is generally an annular structure with an equivalent or relatively high height to diameter ratio, for example in the range of about 1:1-50:1, 1:1-25:1, 1:1-10:1, 2:1-50:1, 2:1-25:1 or 2:1-10:1.

FIG. 3 schematically shows a method of making a removable encapsulated catalyst-containing structure 350, starting with a removable catalyst-containing structure 302 containing catalyst particles in the interior volume 304 thereof, by encapsulating 370 with a coating material 352 according to an embodiment of the present disclosure. In the embodiment of FIG. 3 the encapsulated structure 350 (and the underlying structure 302) is generally an annular structure with an equivalent or relatively low height to diameter ratio, for example in the range of about 1:50-1:1, 1:25-1:1, 1:10-1:1, 1:50-1:2, 1:25-1:2 or 1:2-1:10.

In the below description, reference numbers in the “200s” refer to FIG. 2 and reference numbers in the “300s” refer to FIG. 3. The removable catalyst-containing structure 202 or 302 generally comprises a containment structure configured and dimensioned for insertion or installation within a reactor and generally has external surfaces including region(s) of permeability of access to catalyst within. Catalyst particles are contained within the interior volume 204 or 304 of the catalyst-containing structure 202 or 302. In certain embodiments catalyst particles contained in the interior volume 204 or 304 are fresh catalyst particles. All or a portion of the external surfaces are permeable, in the absence of the coating material, with a plurality of openings permitting fluids to pass through while providing a barrier to retain catalyst particles. The catalyst particles are dimensioned greater than a dimension of the openings. The containment structure is encapsulated in a coating material, for example, comprising heavy paraffins such as C31-C50 paraffins.

As shown in the example embodiments of FIGS. 2 and 3, the catalyst-containing structure 202 or 302 includes a generally circular aperture, annular void 230 or 330, that extends axially through the structure through which fluid feedstocks can be received from upstream in the reactor. The catalyst-containing structure 202 or 302 generally includes a support frame 206 or 306 surrounded by external surfaces including an outer wall 216 or 316, an inner wall 218 or 318 defining the annular void 230 or 330, and end covers 220 or 320. The components of the support frame 206 or 306 can be formed from a suitable material such as tubular or solid metal bars. In one embodiment the support frame 206 or 306 generally includes: end (e.g., top and bottom) outer rings 208 or 308, and optional medial outer ring(s) 208 (shown in FIG. 2, not shown in FIG. 3), which are positioned at and form the outer circumference of the structure 202 or 302; end (e.g., top and bottom) inner rings 210 or 310, and optional medial inner ring(s) 210 (shown in FIG. 2, not shown in FIG. 3), which are positioned at the interior of the ends and form the circumference of the annular void 230 or 330; optional supports 212 or 312 between the outer rings 208 or 308; optional supports 213 or 313 between inner rings 210 or 310; and optional cross-supports 214 or 314 between the outer rings 208 or 308 and the inner rings 210 or 310. In certain embodiments the structure 202 or 302 can include rings 208, 210 or 308, 310 attached to the outer wall 216 or 316, inner wall 218 or 318, and end covers 220 or 320, without supports 212, 213 or 312, 313, whereby the attachment of the outer wall 216 or 316, inner wall 218 or 318, and/or end covers 220 or 320 provides sufficient structural support, and filling the structure 202 or 302 with catalyst in the interior volume 204 or 304 expands the shape. In certain embodiments the cross-supports 214 or 314 are not used, whereby the attachment of the outer wall 216 or 316, inner wall 218 or 318, and/or end covers 220 or 320 provides sufficient structural support. The frame 206 or 306 can also optionally include one or more hooks (not shown) connected to the frame of the basket, to support the structure 202 or 302 and couple it to the internals of the reactor. The hooks can also be used to support the structure 202 or 302 during loading and unloading of the catalyst at the end of the reactor cycle. In addition, similar to the structure described herein with respect to FIG. 1, one of both of the end covers 220 or 320 can be removed to facilitate filling the compartments with catalyst material.

Prior to encapsulating 270 or 370, and after removal of coating material 252 or 353 from the encapsulated catalyst-containing structure 250 or 350, all or a portion of the outer wall 216 or 316, and the inner wall 218 or 318 and/or one or both covers 220 or 320, are permeable; accordingly, in operation, liquid material flows through in either direction through the permeable surfaces while providing a barrier to solid materials of a diameter greater than the diameter of the apertures for permeability, e.g., mesh size in the case of wire mesh, including the catalyst contained in the interior volume 204 or 304 (or any portion thereof not subject to attrition).

In certain example implementations, all or a portion of the outer wall 216 or 316 and all or a portion of the inner wall 218 or 318 are permeable; accordingly, in operation, liquid material flows through in either direction through the outer and inner walls, while providing a barrier to solid materials of a diameter greater than the diameter of the apertures for permeability, e.g., mesh size in the case of wire mesh, including the catalyst contained in the interior volume 204 or 304 (or any portion thereof not subject to attrition). Optionally, all or a portion of the end covers 220 or 320 are also permeable.

In certain example implementations, all or a portion of the outer wall 216 or 316 is permeable, and fluid feedstocks and optionally other reactants such as hydrogen gas in a refinery operation can be received from upstream in the reactor and pass through the outer wall 216 or 316, that is, into the interior of the structure 202 or 302 through the outer wall 216 or 316 for contact with the catalyst contained in the interior volume 204 or 304 for reaction, and reacted fluids are discharged to the exterior of the structure 202 or 302 through the outer wall 216 or 316.

In certain example implementations, all or a portion of the inner wall 218 or 318 is permeable, and fluid feedstocks and optionally other reactants such as hydrogen gas in a refinery operation can be received from upstream in the reactor and pass through the inner wall 218 or 318, that is, into the interior of the structure 202 or 302 through the inner wall 218 or 318 for contact with the catalyst contained in the interior volume 204 or 304 for reaction, and reacted fluids are discharged to the exterior of the structure 202 or 302 through the inner wall 218 or 318.

In certain example implementations, all or a portion of the outer wall 216 or 316 and all or a portion of the inner wall 218 or 318 are permeable, and fluid feedstocks and optionally other reactants such as hydrogen gas in a refinery operation can be received from upstream in the reactor and pass through the outer wall 216 or 316 and the inner wall 218 or 318, that is, into the interior of the structure 202 or 302 through the outer wall 216 or 316 and the inner wall 218 or 318 for contact with the catalyst contained in the interior volume 204 or 304 for reaction, and reacted fluids are discharged to the exterior of the structure 202 or 302 through the outer wall 216 or 316 and the inner wall 218 or 318.

In certain example implementations, all or a portion of the outer wall 216 or 316, all or a portion of the inner wall 218 or 318 and all or a portion of the cover 220 or 320 that is upstream of flow of fluid are permeable, and fluid feedstocks and optionally other reactants such as hydrogen gas in a refinery operation can be received from upstream in the reactor and pass through the outer wall 216 or 316, the inner wall 218 or 318 and the permeable cover 220 or 320, that is, into the interior of the structure 202 or 302 through the outer wall 216 or 316, the inner wall 218 or 318 and the permeable cover 220 or 320 for contact with the catalyst contained in the interior volume 204 or 304 for reaction, and reacted fluids are discharged to the exterior of the structure 202 or 302 through the outer wall 216 or 316 and the inner wall 218 or 318 (optionally with a portion backflowing though the permeable cover 220 or 320).

In certain example implementations, all or a portion of the outer wall 216 or 316, all or a portion of the inner wall 218 or 318 and all or a portion of the cover 220 or 320 that is downstream of flow of fluid are permeable, and fluid feedstocks and optionally other reactants such as hydrogen gas in a refinery operation can be received from upstream in the reactor and pass through the outer wall 216 or 316, the inner wall 218 or 318 and the permeable cover 220 or 320, that is, into the interior of the structure 202 or 302 through the outer wall 216 or 316 and the inner wall 218 or 318 (optionally with a portion backflowing through the permeable cover 220 or 320) for contact with the catalyst contained in the interior volume 204 or 304 for reaction, and reacted fluids are discharged to the exterior of the structure 202 or 302 through the outer wall 216 or 316, the inner wall 218 or 318 and the permeable cover 220 or 320.

All or a portion of the external surface including the wall(s) (the outer wall in the embodiment of FIG. 1 and either or both of the outer and inner walls in the embodiments of FIGS. 2 and 3), and optionally all or a portion of one or both of the end covers, are formed of permeable material having a plurality of apertures permitting fluids to pass through while providing a barrier to retain catalyst particles having one or more dimensions greater than a dimension of the openings.

The external surfaces that are permeable generally comprise a plurality of apertures and wherein the catalyst particles contained within the catalyst-containing structure have dimensions greater than that of the apertures. In certain embodiments, the external surfaces that are permeable comprise wire mesh. In certain embodiments, the wire mesh comprises a wire diameter of about 0.1-0.7, 0.1-0.6, 0.2-0.7, 0.2-0.6, 0.3-0.7 or 0.3-0.6 millimeters and polygonal apertures having sides of about 0.5-3.0, 0.7-3.0, 1.0-3.0, 1.2-3.0, 0.5-2.0, 0.7-2.0, 1.0-2.0, 1.2-2.0, 0.5-1.6, 0.7-1.6, 1.0-1.6 or 1.2-1.6 millimeters. In certain embodiments, polygonal openings are quadrilateral, for example square or rectangular. In certain embodiments, polygonal openings are square with sides of about 1.2-1.6 millimeters. For example, these dimensions are effective to contain 1/16 inch catalyst extrudates (1.5875 millimeters diameter) and ⅛ inch catalyst extrudates (3.175 millimeters diameter).

In certain embodiments permeable walls and/or covers are formed of a wire mesh such as a woven steel mesh. In certain implementations, the wire mesh can be a woven stainless steel mesh, such as a steel wire cloth. In certain implementations, the wire mesh can be a steel wire cloth that is woven characterized by a mesh formed of wire having a diameter of about 0.508 millimeters (0.020 inch) with 14 wires per in in a grid (forming square apertures having sides of about 1.306 millimeters). However, depending on the application, other wire mesh sizes can be used, and other materials for the wire mesh may be used. The wire mesh of the inner and outer walls can be secured to the support frame components using wire, or other suitable attachment structures and methods are also contemplated such as brackets or welds.

In certain implementations, permeable walls and/or covers can be formed of sheets of suitable material such as steel or stainless steel having a plurality of apertures appropriately dimensioned as noted above to impart permeability and attached by suitable structure and method such as wires, brackets and/or welds.

In certain embodiments, the catalyst-containing structure (e.g., 102, 202 or 302 herein) is formed having one or more chambers as separate layers along the axial direction, one or more compartments separated radially, or both one or more chambers as separate layers along the axial direction and one or more compartments separated radially.

In certain implementations, a catalyst-containing structure is in the form of a catalyst reactor basket comprising: an outer side wall extending along the outer circumferential periphery of the basket and extending in an axial direction to define a generally cylindrical inner volume of the basket, at least a portion of the outer side wall being fluid permeable; an inner side wall disposed within the outer side wall, the inner side wall extending circumferential and axially to define an aperture that defines a inner boundary of the volume of the basket, the aperture being sized and shaped to allow a fluid to flow axially with respect to the basket, at least a portion of the inner side wall being fluid permeable; first and second covers disposed on opposite ends of the outer side wall and inner side wall, the first and second covers defining respective ends of the inner volume of the basket, at least a portion of the first and second covers being fluid permeable; a dividing wall disposed between the first and second covers, the dividing wall defining a first and second chamber within the inner volume of the basket, at least a portion of the dividing wall being fluid permeable; and a plurality of partitions disposed within the first and second chambers, each partition extending radially between the outer side wall and the inner side wall and extending axially between the dividing wall and a respective cover, the plurality of partitions defining a plurality of compartments within the first and second chambers, each compartment being sized and shaped to receive a catalyst.

In certain implementations, a structural arrangement of a basket in which each chamber includes multiple compartments allows for testing several different catalysts at the same time. In addition, dividing the basket into an upper chamber and a lower chamber allows for two-stage reactions in a single pass of the fluid in the axial direction along the basket. For example, in one compartment of one chamber a first catalyst is provided. In a second, corresponding compartment in the other chamber (i.e., the second compartment is axially aligned with the first compartment) a second catalyst is provided. Accordingly, fluid can pass through two layers of catalyst having differing properties. For example, the liquid can pass through the first compartment and come into contact with the catalyst contained therein. The catalyst in the first compartment can be one that hydrotreats the fluid by removing heteroatoms such as sulfur and nitrogen, and hydrogen, from the fluid. As the fluid travels along the axial direction of the basket the fluid enters the second compartment in the next chamber of the basket. The second compartment can include a different catalyst that can be used for cracking or further hydrogenation of the liquid as it comes into contact with the catalyst contained in the compartment. Two-stage reactions can thus be achieved with the catalyst basket herein. The design is made to simulate a once-thru hydrocracking unit with two reactors in series of a single pass of the fluid through the basket. In addition, adjacent compartments can contain different catalyst materials so that different catalyst combinations can be tested simultaneously using the same reactor basket.

In certain implementations, a two layer, multi-compartment design of a catalyst basket allows different combinations of catalysts to be tested using the same basket. For example, two different compartments in the first layer can contain catalysts A1 and A2. In addition, two different compartments in the second layer can contain catalysts B1 and B2. Accordingly, as the fluid passes through the reactor basket, the fluid is exposed to different combinations of catalysts. For example, one fluid flow path through the basket can first expose the fluid to the catalyst A1 contained in one compartment in the first layer of the basket. After the fluid is exposed to the catalyst A1, it passes into the second layer of the basket whereupon it is exposed to the second catalyst B1 contained in a compartment in the second layer of the basket. Similarly, the fluid can progress through another flow path in which the fluid is exposed to catalyst A2 in another compartment in the first layer of the basket and then is exposed to catalyst B2 in another compartment in the second layer of the basket. As such, the fluid flowing through the reactor basket and be exposed to a combination of catalysts A1 and B1 and, using the same catalyst basket in the same reactor, the fluid simultaneously can be exposed to the combination of catalysts A2 and B2. Accordingly, multiple combinations of catalysts can be tested in the same chamber using the same basket simultaneously. As such, implementations of the basket designs herein allows for efficient and effective testing of many catalysts and combinations so that more suitable and effective catalysts can be identified and employed in future reactions.

In certain implementations, a catalyst-containing structure is in the form of a catalyst reactor basket arranged to receive a combination of catalysts in separate chambers, comprising: an outer side wall extending along the outer periphery of the basket and extending to define an inner volume of the basket; an inner side wall disposed within the outer side wall, the inner side wall extending to define an aperture that defines a inner boundary of the volume of the basket, the aperture being sized and shaped to allow a fluid to flow axially with respect to the basket; first and second covers disposed on opposite ends of the outer side wall and inner side wall, the first and second covers defining respective ends of the inner volume of the basket, at least a portion of the first and second covers being fluid permeable; and a dividing wall disposed between the first and second covers, the dividing wall defining a first and second chamber within the inner volume of the basket, at least a portion of the dividing wall being fluid permeable, wherein each of the first and second chambers being sized to receive a respective catalyst so as to enable a two-stage reaction in a single pass of the fluid in the axial direction.

In certain implementations, a catalyst-containing structure is in the form of a layered catalyst basket for testing catalysts in a reactor, comprising: an annular structure having an inner aperture allowing fluid feedstock flow through the structure, the annular structure having a plurality of layers arranged axially and separated from each other by fluid-permeable material, at least one of the plurality of layers containing a primary catalyst to be tested for a chemical process, and at least one layer positioned upstream with respect to the at least one layer containing the primary catalyst containing a grading material, and wherein the grading material is adapted to filter out contaminants within the feedstock and to thereby protect the primary catalyst; and wherein at least one of the plurality of layers includes radial dividers that create intralayer compartments.

A coating material (for example coating material 152, 252 or 352 herein) is applied to all or a portion of a catalyst-containing structure (for example catalyst-containing structure 102, 202 or 302 herein, at an encapsulating step, for example encapsulating step 170, 270 or 370 herein). In certain embodiments, the coating material is applied to external surfaces of the catalyst-containing structure that are permeable, that is, formed of permeable material having a plurality of apertures permitting fluids to pass through while providing a barrier to retain catalyst particles having one or more dimensions greater than a dimension of the openings. In such embodiments, coating material also may be applied all or a portion of non-permeable surfaces, including those that are adjacent to the permeable surfaces. For example, in implementation in which one or more hooks are present that are attached to non-permeable surfaces of the catalyst-containing structure, that coating material would not be applied at those locations, and the hooks themselves are not coated; at an interface of non-permeable surfaces adjacent to the permeable surfaces, coating is present and extends contiguously to the encapsulate the permeable surface. In certain embodiments, one or more hooks may be provided that can be coated (e.g., hinged so that they lie against the external surface of the catalyst-containing structure); the entire catalyst-containing structure is coated; and at the time of installation the location with the hook can be subjected to ex situ removal to expose the hook to facilitate installation of the catalyst-containing structure in the reactor (e.g., a remainder of the wax not removed ex situ is removed in situ as described herein).

The coating material is generally a material that is formed into a liquid phase for the coating process as described herein, and that when solidified, retains all, a major portion, a significant portion or a substantial portion of the solidified coating material during handling and transport of the encapsulated catalyst-containing structure (e.g., encapsulated catalyst-containing structure 150, 250 or 350 herein). For example, when the catalyst-containing structure is deployed, the coating material is stripped prior to or during a startup period after the encapsulated catalyst-containing structure (for example encapsulated catalyst-containing structure 150, 250 or 350 herein) is loaded in a reactor.

The coating material comprises a heavy paraffin or a mixture containing one or more heavy paraffins having carbon numbers in the range 31-50 (C31-C50 paraffins) In certain implementations, the coating material comprises, consists essentially of or consists of a heavy paraffin including a C31-C50 paraffin. In certain implementations, the coating material comprises, consists essentially of or consists of a mixture of two or more heavy paraffins including two or more different carbon number C31-C50 paraffins. In certain implementations, the coating material comprises, consists essentially of or consists of a mixture of two or more heavy paraffins including two or more types of C31-C50 or C40-C50 paraffins (e.g., normal paraffin (n-paraffin) and iso-paraffin). In certain implementations, the coating material comprises, consists essentially of or consists of a mixture of two or more heavy paraffins including two or more different carbon number C31-C50 paraffins and two or more types of C31-C50 or C40-C50 paraffins (e.g., n-paraffin and iso-paraffin). In certain embodiments of the above implementations, the paraffins comprise at least a major amount, a significant amount or a substantial amount of a n-paraffin. In certain embodiments of the above implementations, the paraffins consists essentially of or consists of n-paraffins.

In additional implementations, the coating material comprises, consists essentially of or consists of a mixture containing the one or more heavy C31-C50 paraffins as a heavy paraffinic component, and a light paraffinic component including one or more paraffins having lower carbon numbers. In certain embodiments the light paraffinic component comprises, consists essentially of or consists of one or more C14-C30, C15-C30, C16-C30, C17-C30, C18-C30 or C19-C30 paraffins. In certain embodiments: at least a portion of the paraffins in the heavy paraffinic component comprise, consist essentially of or consist of n-paraffins; and at least a portion of the paraffins having lower carbon numbers comprise n-paraffins. In certain embodiments: at least a major amount, a significant amount or a substantial amount of the paraffins in the heavy paraffinic component comprise, consist essentially of or consist of n-paraffins; and at least a portion of the paraffins having lower carbon numbers comprise, consist essentially of or consist of n-paraffins. In certain embodiments: at least a portion of the paraffins in the heavy paraffinic component comprise, consist essentially of or consist of n-paraffins; and at least a major amount, a significant amount or a substantial amount of the paraffins having lower carbon numbers comprise, consist essentially of or consist of n-paraffins.

In certain embodiments in which the coating material comprises, consists essentially of or consists of a mixture containing the one or more heavy C31-C50 paraffins as a heavy paraffinic component, and a light paraffinic component including one or more paraffins having lower carbon numbers, the lowest melting point is greater than the expected temperature of the environment until the atmosphere is acceptable for the coating material to be melted, for example, greater than about 40, 45 or 50° C., in certain embodiments about 40-95, 40-90, 40-85, 45-95, 45-90, 45-85, 50-95, 50-90 or 50-85° C. This environment includes, for example, outside air temperatures if the encapsulated catalyst-containing structure is exposed to such temperatures, which may, for example, reach as high as about 50° C. In embodiments in which temperatures can be controlled in the environment for storage, transport and handling prior to deployment (e.g., indoor climate controlled such as about 18-25 or 20-25° C.), lower melting point paraffins may be effective for one or more light paraffin components consistent with the expected environment, such as C16, C17 and/or C18 paraffins. In embodiments in which temperatures can be refrigerated in the environment for storage, transport and handling prior to deployment (e.g., such as about 0-15° C.), even lower melting point paraffins may be effective for one or more light paraffin components consistent with the expected environment.

During the encapsulation step of the catalyst-containing structure a method of making the encapsulated structure catalyst-containing structure (for example encapsulated catalyst-containing structure 150, 250 or 350, by encapsulation step 170, 270 or 370 herein) generally comprises: providing the catalyst-containing structure; loading catalyst particles in an interior volume of the catalyst-containing structure; preparing the coating material by forming into a liquid phase as a liquified coating material or liquified coating material solution; applying the liquified coating material, or coating material solution or suspension, to the external surfaces of the catalyst-containing structure; and transforming the coating material to a solid phase.

The liquified coating material, or coating material solution or suspension, may be applied to the catalyst-containing structure (for example catalyst-containing structure 102, 202 or 302 herein) by processes including but not limited to spraying, pouring and/or immersion (e.g., dipping). In certain embodiments two or more techniques are used, for example, spraying and immersion, pouring and immersion, spraying and pouring, in various sequences. In certain embodiments two or more techniques are used including spraying and immersion.

In certain embodiments, applying the liquified coating material, or coating material solution or suspension, to the external surfaces of the catalyst-containing structure comprises immersion, whereby: (a) the liquified coating material, or coating material solution or suspension, is provided in a vessel larger than the catalyst-containing structure; (b) the catalyst-containing structure is immersed in vessel containing the liquified coating material, or coating material solution or suspension, for a suitable time period, for instance about 0.1-10, 0.5-10, 1-10, 0.1-5, 0.5-5 or 1-5 minutes; (c) lifting the catalyst-containing structure from the vessel; and (d) solidifying the coating material to form the encapsulated structure catalyst-containing structure. In certain embodiments, steps (b)-(d) are repeated, for example, 2-10 times, to build a thicker coating, and in step (a), sufficient liquified coating material, or coating material solution or suspension, is provided for multiple immersions, and/or liquified coating material or liquified coating material is added between one or multiple immersions (e.g., after two immersions, additional liquified coating material or liquified coating material is provided). In certain embodiments, steps (b)-(d) are repeated, wherein the catalyst-containing structure is rotated between one or multiple immersions so as to coat all surfaces more evenly. In certain embodiments, steps (b)-(d) are repeated, wherein: in a first instance of step (b) the catalyst-containing structure is inserted while rotated at a first angle, and a first instance of steps (c) and (d) are carried out; and in a second instance of step (b) the catalyst-containing structure is inserted while rotated at a second angle, and a second instance of steps (c) and (d) are carried out; wherein the first and second angles can be different from one another by 1-180, 2-180, 10-180, 30-180, 60-180 or 90-180 degrees. In certain embodiments, steps (b)-(d) are repeated, wherein: in a first instance of step (b) the catalyst-containing structure is inserted while rotated at a first angle, and a first instance of steps (c) and (d) are carried out; in a second instance of step (b) the catalyst-containing structure is inserted while rotated at a second angle, and a second instance of steps (c) and (d) are carried out; and in an Nth instance of step (b) the catalyst-containing structure is inserted while rotated at a Nth angle, and an Nth instance of steps (c) and (d) are carried out; wherein N can be third through one-hundredth, third through fiftieth, third through twentieth or third through tenth (e.g., for a total of 3-100, 3-50, 3-20 or 3-10 instances of step (a); and wherein the angles can be varied at regular intervals, random intervals, or irregular intervals (for example: if regular intervals and there are 18 repetitions the angle difference between steps about 20 degrees; if irregular or random intervals, additional repetitions might be necessary for complete coverage).

In certain implementations, a liquified coating material is provided as a melted phase by exposing to elevated temperature conditions, generally at or above the melting point of the selected paraffin or paraffin composition. In an embodiment, to apply the coating, for example as in encapsulating step 170, 270 or 370 herein, the coating material is heated in a vessel to a suitable temperature and pressure for melting to a phase that is all or substantially liquid phase. In an embodiment, to apply the coating to the catalyst-containing structure, for example as in encapsulating step 170, 270 or 370 herein, the coating material is heated to a paste-like constancy (e.g., with one or more some components of higher carbon number paraffin such as C47-C50, C48-C50, C49-C50 or C50 in solid phase) and spread over at least the permeable material of the catalyst-containing structure, e.g., by trowel-spreading the paste.

The temperature and pressure conditions for melting coating material are selected so as to be below the boiling point of the selected coating material (so as to avoid vaporization thereof during the coating process). The pressure for melting is typically in the range of atmospheric pressure (for instance about 100 kilopascals) to about 300 kilopascals. In certain embodiments, temperature(s) for melting are selected above the melting point of the coating material to provide a liquid phase coating material. In certain embodiments, coating material is a combination of paraffins, and wherein a temperature for melting is selected above the melting point of the highest carbon number paraffin to provide a liquid phase coating material. In certain embodiments, coating material is a combination of paraffins, and wherein a temperature for melting is selected below the melting point of one or more high carbon number paraffins and above the melting point of the remainder of the paraffins, to provide a mixed phase liquids (the remainder of the paraffins) and solids (the one or more high carbon number paraffins). In a mixture of coating materials, a melting point is based on the composition of the mixture, for instance using the highest melting point and the lowest boiling point of the range of components. Table 1 shows properties for certain n-alkanes. In Table 1, data is from the National Library of Medicine, PubChem (site: https://pubchem.ncbi.nlm.nih.gov), using the values from the source EPA DSSTox. Exceptions are n-tetracontane where the boiling point is obtained from Peter Morgan, Analysis of Petroleum Fractions by ASTM D2887, Thermo Fisher Scientific Inc. (2012) (publication AN20582_E 08/12S) https.//static.thermoscientific.com/images/D22163~.pdf, and where the data for melting and boiling point data for n-pentacontane and n-hexacontane is from https://www.engineeringtoolbox.com/hydrocarbon-boiling-melting-flash-autoignition-point-density-gravity-molweight-d_1966.html.

In certain embodiments in which the encapsulation step of the catalyst-containing structure is carried out including preparing the coating material as a liquefied coating material by melting, the melting is carried out at a temperature of above the melting point of the highest melting material which remains as part of the coating material on the encapsulated catalyst-containing structure (that is, prior to removal). In addition, the maximum temperature during encapsulation should not exceed the boiling point of the lowest boiling component of the coating mixture which remains as part of the coating material on the encapsulated catalyst-containing structure (that is, prior to removal), as opposes to a solvent, carrier or other components that are not intended to be retained as part of the encapsulated catalyst-containing structure. For example, in embodiments in which the range of intended components on the finished coated catalyst range from C19 to C50, the minimum melting temperature is at least about 92° C., and the maximum melting temperature is no greater than about 331° C.

In embodiments in which the encapsulation step of the catalyst-containing structure is carried out including preparing the coating material as a coating material solution or suspension, solvent is added to the coating material. In certain embodiments a coating material solution is initially in liquid phase, and lower temperatures can be used for encapsulation; the encapsulation process temperature and pressure conditions are selected so that the coating material remains in liquid phase, whereby the coating material does not precipitate as a solid nor does it vaporize as a gas.

In certain implementations, a liquified coating material is provided as a solution with a solvent. In certain embodiments, the selected paraffin or paraffin composition forming the coating material is dissolved in a suitable solvent or combination of solvents. In certain embodiments selected paraffin or paraffin composition forming the coating material is partially dissolved providing a two-phase system. If the solid paraffin is to dissolve in the liquid solvent, there will initially be a mixed phase until the paraffin has dissolved; temperature, time and stirring speed (or agitation) will dictate the speed at which the two-phase solid/liquid becomes a single liquid phase. The solvent(s) are effective for dissolving the coating material and is/are also removable to form the final encapsulating coating. A liquified coating material is provided as a solution con contain any suitable quantity of coating material, for instance 0.1-99, 0.1-90, 0.1-80, 0.1-70, 0.1-60, 0.1-50, 0.1-25, 0.1-10, 0.1-5, 1-99, 1-90, 1-80, 1-70, 1-60, 1-50, 1-25, 1-10, 1-5, 5-99, 5-90, 5-80, 5-70, 5-60, 5-50, 5-25 or 5-10 mass percent of the coating material relative to the mass of the solution including the solvent(s).

In embodiments using heavy paraffin coating materials, a solvent can be used to prepare the coating material by forming into a liquid phase as a liquified coating material solution. For example, such solvents include light paraffinic or aromatic solvents (preferably contaminant free to maintain integrity of the catalyst), and have a carbon number in the range of 5-7, instance including one or more of pentane, hexane, benzene, toluene, or a mixture thereof. In certain embodiments a naphtha or light naphtha fraction (preferably hydrotreated), for example boiling in the range of about 36-100, 36-90, 36-80, 36-70 or 36-60° C., can be used. After sufficient liquified coating material is applied to the catalyst-containing structure, solvent is removed by heating to a temperature above the solvent boiling point and below the coating material melting point.

In embodiments in which liquified coating material is provided as a melted coating material, solidifying the coating material, for instance after one or more cycles of applying the melted coating material by spraying, pouring and/or immersion, comprises exposing the catalyst-containing structure having liquified coating material to temperatures below the melting point of the coating material. In certain embodiments solidifying comprises exposing the catalyst-containing structure having liquified coating material to ambient temperatures (e.g., 20-22° C.). In certain embodiments solidifying comprises exposing the catalyst-containing structure having liquified coating material to temperatures lower than ambient, for example −20−20, −20−10, −20−5, −20−0, −10−20, −10−10, −10−5 or −10−0° C., to increase the rate of solidification. In embodiments in which solidifying is at temperatures lower than ambient, fewer cycles of immersions may be carried out to solidify the coating material.

In embodiments in which a coating material solution or suspension is used, solidifying the coating material, for instance after one or more cycles of applying the coating material solution or suspension by spraying, pouring and/or immersion, comprises evaporation of the solvent used for the solution liquified coating material solution. For example, in embodiments in which the selected paraffin(s) is/are dissolved in the solvent, when the solvent is evaporating the paraffin will precipitate and form the coating on the surface, since solubility decreases as the amount of solvent present decreases due to evaporation. Further, in embodiments in which the selected paraffin(s) is/are dissolved in the solvent, spraying is an effective coating method. In embodiments in which the selected paraffin(s) is/are partially dissolved and solids remain in a suspension, as the solvent evaporates the system will turn to a gel-like system before turning waxier as more solvent is removed and the material forms the coating on the surface. In these embodiments using solvents, coating may comprise coating one side or area of the catalyst-containing structure at a time, allowing that side or area to solidify, coating another side or area and allowing to dry, and repeating as necessary.

The amount of coating material provided and number of steps, or coating cycles, are sufficient to encapsulate the exposed surfaces of the catalyst-containing structure. In embodiment of FIG. 1, the encapsulated catalyst-containing structure 150 includes the coating material 152 covering the outer wall 116 and the ends 120. In embodiment of FIGS. 2 and 3, the encapsulated catalyst-containing structure 250 or 350 includes the coating material 252 or 352 covering the outer wall 216 or 316, the inner walls 218 or 318, and the ends 220 or 320. The coating thickness of the encapsulated catalyst-containing structure can be of a suitable value or range to seal the catalyst-containing structure and prevent air and/or moisture from accessing the catalyst. For example, the coating thickness of the encapsulated catalyst-containing structure can be in the range of about 0.2-2.0, 0.2-1.8, 0.2-1.6, 0.4-1.5, 0.2-1.4, 0.4-2.0, 0.4-1.8, 0.4-1.6, 0.4-1.5 or 0.4-1.4 millimeters. In certain embodiments, an encapsulating step includes or is preceded by removal of all or substantially all of any dust or powder on the catalyst particles or the catalyst-containing structure prior to coating.

In one embodiment, the coating material is heated in a coating material vessel and maintained in a liquefied state, under temperature conditions generally described above. In coating processes without solvent, conditions for melting and maintaining the liquid state include pressures in the range of about 100-300 kilopascals, and temperatures in the range of about 30-331, 30-300, 30-250, 30-200, 50-331, 50-300, 50-250, 50-200, 70-331, 70-300, 70-250 or 70-200° C. The temperature and pressure of the coating material vessel should be well below the vaporization or decomposition temperature and pressure of the coating material.

In coating processes with a solvent, conditions for forming the coating material solution or suspension and maintaining the liquid state include pressures in the range of about 100-300 kilopascals, and temperatures in the range of about 15-80, 15-50, 15-30, 20-80, 20-50, 20-30, 25-80, 25-50, or 25-30° C.

In certain embodiments, the liquified coating material, or coating material solution or suspension, is sprayed on the catalyst-containing structure, for instance via one or more suitable nozzles. In certain embodiments, for instance in a batch process, a catalyst-containing structure can be sprayed with the liquified coating material or coating material solution. In further embodiments, for instance in a continuous process, catalyst-containing structures can traverse so that they can be sprayed with the liquified coating material or coating material, for instance using a conveyor belt. Excess coating material can be collected and recycled back to the coating material vessel for reuse.

In certain embodiments, liquified coating material, coating material solution or suspension, is poured over a catalyst-containing structure. For example, a coating material solution or suspension may be poured into a mold. In certain implementations, a coating material solution or suspension may be poured from the top; after solidification the basket catalyst-containing structure is rotated or inverted, exposing another side or area, and a coating material solution or suspension is pouted on the exposed side or area.

In certain embodiments, the catalyst-containing structure is immersed in the liquified coating material or coating material solution, followed by draining.

Table 1 shows melting and boiling points of n-paraffinic wax used in embodiments herein for manufacture of nonabsorptive catalyst product. A suitable range of n-paraffins wax (carbon numbers 31-50) is shown in a rectangular box; these have high melting points, ranging from about 67.9-92° C., which is an effective range for use as coating material for the catalyst particles as described herein, as said coating materials remain intact during ambient conditions including the extremes that may be encountered in refinery operations, and also readily melt, for example at the temperature conditions used during reactor startup so that the wax can be removed.

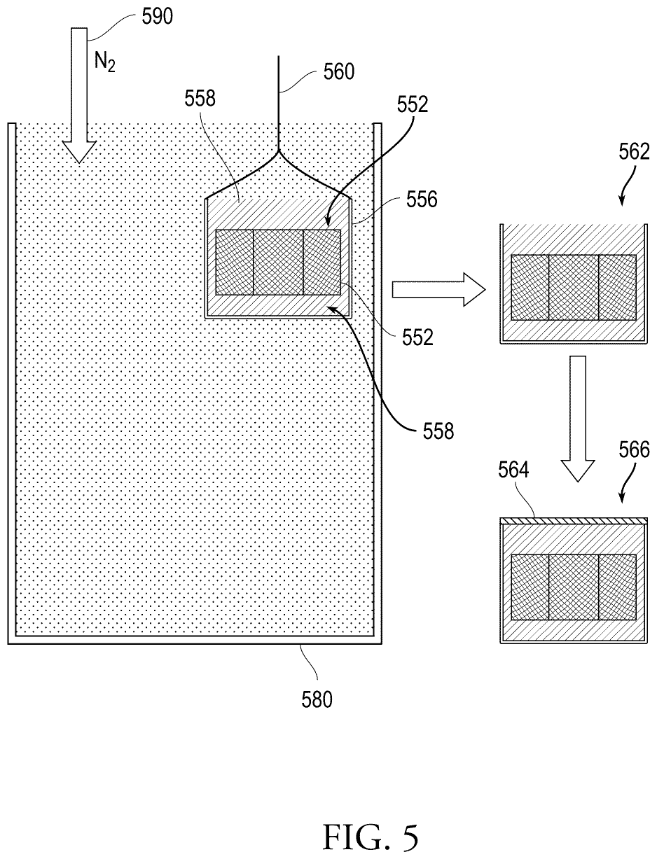

When a catalyst-containing structure is to be deployed in a reactor, the encapsulated catalyst-containing structure is provided and coating material is removed in situ, ex situ, or a combination thereof. The encapsulated catalyst-containing structure (optionally with some or all coating material removed) is inserted in the reactor during or after loading of catalyst in the reactor, for instance, through a designated reactor manway during catalyst loading of the reactor. For example, in one implementation, a portion of catalyst is loaded, the encapsulated catalyst-containing structure (optionally with some or all coating material removed) is inserted in the reactor atop the loaded catalyst, and additional catalyst is added, so that the encapsulated catalyst-containing structure is completely surrounded by the principal catalyst, and hence, the encapsulated catalyst-containing structure is secured in place. In certain embodiments the catalyst-containing structure is inserted in the reactor by installation with hooks or other structures or techniques known in the use of catalyst baskets. After removal of the coating material, the catalyst-containing structure is used as intended, for example, for testing of performance of catalysts. After a testing cycle or at suitable another time, the catalyst-containing structure with spent catalyst is removed, for example, for testing and evaluation of the catalyst. Spent catalyst particles generally have, for example, contaminant metals and/or and coke deposited thereon or within pores thereof, and have reduced catalytic activity compared with the initial activity of the catalyst particles. In certain embodiments encapsulation is carried out at the time of removal as described further herein (for example with respect to FIG. 5) to improve safety and minimize or eliminate environmental contamination. The catalyst within the catalyst-containing structure is then tested according to known protocols, for example to ascertain one or more of catalyst effectiveness, catalyst selectivity, activity, remaining catalyst life and/or regeneration. In certain embodiments, when recovered, the catalysts can be regenerated by combustion. In certain embodiments the recovered catalysts can be tested in a pilot plant to determine one or more of: catalyst selectivity, activity, and remaining life. In addition, recovered catalysts and optionally regenerated recovered catalysts can be analyzed for physical properties and chemical composition. For example, a metal deposition profile of the catalyst within the catalyst-containing structure can be determined.

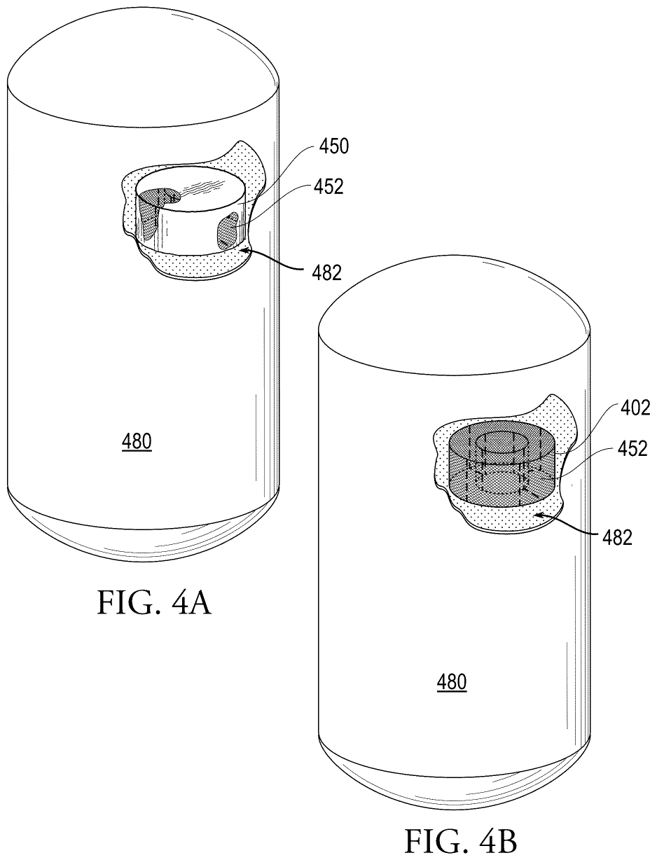

In certain implementations, a method for catalyzing a fluid is provided using the encapsulated catalyst-containing structure. In certain implementations, a method for testing a catalyst is provided using the encapsulated catalyst-containing structure. Referring to FIG. 4A, use of an encapsulated catalyst-containing structure 450 is described, for instance for catalyzing a fluid and/or testing a catalyst. The encapsulated catalyst-containing structure 450 having catalyst particles 452 therein may be the same or similar to encapsulated catalyst-containing structure 150, 250 or 350 herein, or another suitable catalyst-containing structure encapsulated with coating material. In certain embodiments catalyst particles 452 are fresh catalyst particles. For example, a reactor 480, such as a fixed bed reactor, containing reactor-contained catalyst 482 (separate from the catalyst 452 within the encapsulated catalyst-containing structure 450 and the underlying catalyst-containing structure), is provided. In operation reactor 480 is in fluid communication with a source of feedstock, and in embodiments of hydroprocessing reactors, a source of hydrogen (not shown); effluents, typically gases or mixed liquid and gases are discharged.

Prior to and/or commensurate with use in the reactor 480 (e.g., start-up operations, catalyst pre-treating such as pre-sulfiding, and/or hydroprocessing a hydrocarbon feedstock), the coating material is removed from the encapsulated catalyst-containing structure 450 (ex situ and/or in situ, as described herein) to free the external surfaces, particularly the permeable surfaces of the underlying catalyst-containing structure such as one or more of the outer wall(s), optionally inner wall(s) and end covers, of the coating material. Accordingly, in operation the catalyst particles within catalyst-containing structure are accessible.

In certain embodiments, the coating material is removed from the encapsulated catalyst-containing structure 450 entirely by in situ removal, and as described herein, and as shown in FIG. 4B, the reactor 480 operates with the containing reactor-contained catalyst 482 and with catalyst particles 404 in the catalyst-containing structure 402, that are exposed to the fluids in the reactor via permeable external surfaces (for example, with certain implementation as described herein).

In certain embodiments, the coating material is removed from the encapsulated catalyst-containing structure entirely by ex situ removal, and the resulting catalyst-containing structure 402 with catalyst particles 452 therein is inserted in the reactor 480 as shown in FIG. 4B. In certain embodiments, a portion of coating material is removed from the encapsulated catalyst-containing structure by ex situ removal, and a remainder is left on the catalyst-containing structure; the resulting catalyst-containing structure with a portion of the initial coating material is inserted in the reactor for in situ removal of that remainder portion.

Example hydrocarbon feedstocks that may be processed in the reactor 480 include crude oil fractions such as naphtha, diesel, vacuum gas oil, vacuum residue or intermediate refinery streams such as deasphalted oil, coker naphtha, coker gas oil, fluid catalytic cracking naphtha or fluid catalytic cracking cycle oils. Hydroprocessing reactions are selected from the group consisting of hydrodesulfurization, hydrodenitrogenation, hydrodemetallization, hydrocracking, hydrogenation, hydroisomerization, and combinations of two or more of the foregoing reactions.

In certain embodiments, coating material is removed from the catalyst-containing structure ex situ. In certain embodiments, in situ removal of coating material, ex situ removal of coating material, or ex situ followed by in situ removal of coating material, occurs an inert atmosphere. In certain embodiments, in situ removal of coating material, ex situ removal of coating material, or ex situ followed by in situ removal of coating material occurs in an atmosphere free or substantially free of oxygen or water to prevent or minimize deactivation of the catalyst material within the catalyst-containing structure. Prior to introduction into a reactor, all or a portion of the coating material is removed. In certain embodiments, ex situ removal includes mechanically removing a portion of the coating material (which may be reused as coating material for another catalyst-containing structure or added as additional feedstock in the reactor); the partially coated catalyst-containing structure is then inserted in the reactor whereby the remainder of coating material is removed in situ. In certain embodiments, ex situ removal includes heating the encapsulated catalyst-containing structure, for example, by heating in a suitable vessel or tub to melt the coating material for partial or complete removal (where the removed coating material coating material may be reused as coating material for another catalyst-containing structure or added as additional feedstock in the reactor); if the coating material is partial removal, the partially coated catalyst-containing structure is then inserted in the reactor whereby the remainder of coating material is removed in situ.

In certain embodiments, in situ removal comprises stripping during startup including melting the coating material from the catalyst-containing structure, and accordingly the selection of the coating material or coating material mixture includes those having a melting point in the range of the reactor startup temperature. For instance, the catalyst-containing structure that is encapsulated or partially encapsulated (e.g., if some ex situ removal has occurred) in the coating material is loaded in a reactor, and the temperature is increased (for example, from ambient temperature) up to the eventual reactor operating temperature. For instance, when C50 paraffins are used as all or part of the coating material or coating material mixture, for example with a melting point of about 92° C., startup conditions over that temperature are used, for instance in the range of about 150-500, 200-500, 150-450, 200-450, 150-400, 200-400, 150-360, 200-360, 150-340 or 200-340° C. are suitable.

In situ removal of coating material (as the only means of removal of coating material, or subsequent to an ex situ removal step) occurs during any heating stage in an appropriate atmosphere. In certain embodiments, upon startup of the reactor 480, temperature and pressure conditions result in melting of the coating material on the encapsulated catalyst-containing structure 450. For example, in an initial heating step, hydrogen is heated by fired heaters to heat the catalyst and reactor walls prior pressure ramp-up. This achieves the required minimum pressurization temperature in order shift the reactor walls from brittle to ductile phase prior pressurizing the system. In certain embodiments, flushing oil is typically introduced as preparation for low and high and/or low temperature catalyst activation, and molten coating material passes with the flushing oil.

In certain embodiments, after startup of the reactor 480, the reactor-contained catalyst 482 is subjected to a catalyst pre-treatment or pre-activation step such as a sulfur treatment, known as pre-sulfiding, and temperature and pressure conditions during such a sulfur treatment step results in melting of coating material on the encapsulated catalyst-containing structure 450 (if any remains). For example, heat is applied in the presence of hydrogen, a hydrocarbon fluid and a sulfur-containing activating agent, e.g. dimethyldisulfide (DMDS).

In certain embodiments, reactor 480 with the encapsulated catalyst-containing structure 450 therein operates under a nitrogen environment or blanket during startup; the reactor system will be heated up and the pressure will be raised prior to a pre-sulfiding step; the coating material will be removed from the encapsulated catalyst-containing structure 450 during this the startup stage of heating and pressure increase; the reactor system pressure will then be increased by hydrogen until it reaches conditions required for pre-sulfiding the catalyst. Coating material removed from the encapsulated catalyst-containing structure 450 may react, for example, by cracking and/or isomerization, depending on the reaction conditions and selected catalyst.

In other embodiments herein, removal of a catalyst-containing structure having spent or contaminated catalyst therein is provided. The catalysts particles that have been subject to reaction would typically be exposed to air during the removal and are dangerous to handle. For example, in certain instances a catalyst-containing structure remains in a reactor for a long period of time, for example, 6-60, 6-48, 6-36, 2-24, 12-60, 12-48, 12-36 or 12-24 months. The catalyst particles may contain contaminants, depending on the type of reaction, inducing but not limited to one or more of coke, wash oil, hydrogen sulfide or metals or metal compounds such as nickel carbonyl, iron sulfide, vanadium, and/or sodium. In addition, the spent catalyst particles are susceptible to exothermic autothermal reactions, and may be pyrophoric, during removal and transport of the catalyst-containing structure having spent or contaminated catalyst therein.

An encapsulating material is used to protect the catalyst-containing structure having spent or contaminated catalyst therein. The encapsulating material is formed about the catalyst-containing structure having spent or contaminated catalyst therein to encapsulate and create an airtight and watertight seal. The airtight and watertight seal formed by the encapsulating material minimizes or prevents ingress of air and/or water from the environment to contacting the spent or contaminated catalysts particles, which minimizes or eliminates exothermic autothermal reactions. The airtight and watertight seal formed by the encapsulating also minimizes or prevents egress of contaminants, inducing but not limited to one or more of coke, wash oil, hydrogen sulfide or metals or metal compounds such as nickel carbonyl, iron sulfide, vanadium, and/or sodium, to the external environment, which minimizes or eliminates environmental contamination and health hazards associated with handling of the catalyst-containing structure having spent or contaminated catalyst therein.

The encapsulating material is generally a material that is formed into a liquid phase for the encapsulating process as described herein, and that when solidified, retains all, a major portion, a significant portion or a substantial portion of the solidified encapsulating material during handling and transport of the encapsulated catalyst-containing structure having spent or contaminated catalyst therein.

The encapsulating material comprises a heavy paraffin or a mixture containing one or more heavy paraffins having carbon numbers in the range 31-50 (C31-C50 paraffins). In certain implementations, the encapsulating material comprises, consists essentially of or consists of a heavy paraffin including a C31-C50 paraffin. In certain implementations, the encapsulating material comprises, consists essentially of or consists of a mixture of two or more heavy paraffins including two or more different carbon number C31-C50 paraffins. In certain implementations, the encapsulating material comprises, consists essentially of or consists of a mixture of two or more heavy paraffins including two or more types of C31-C50 or C40-C50 paraffins (e.g., normal paraffin (n-paraffin) and iso-paraffin). In certain implementations, the encapsulating material comprises, consists essentially of or consists of a mixture of two or more heavy paraffins including two or more different carbon number C31-C50 paraffins and two or more types of C31-C50 or C40-C50 paraffins (e.g., n-paraffin and iso-paraffin). In certain embodiments of the above implementations, the paraffins comprise at least a major amount, a significant amount or a substantial amount of a n-paraffin. In certain embodiments of the above implementations, the paraffins consists essentially of or consists of n-paraffins.

In additional implementations, the encapsulating material comprises, consists essentially of or consists of a mixture containing the one or more heavy C31-C50 paraffins as a heavy paraffinic component, and a light paraffinic component including one or more paraffins having lower carbon numbers. In certain embodiments the light paraffinic component comprises, consists essentially of or consists of one or more C14-C30, C15-C30, C16-C30, C17-C30, C18-C30 or C19-C30 paraffins. In certain embodiments: at least a portion of the paraffins in the heavy paraffinic component comprise, consist essentially of or consist of n-paraffins; and at least a portion of the paraffins having lower carbon numbers comprise n-paraffins. In certain embodiments: at least a major amount, a significant amount or a substantial amount of the paraffins in the heavy paraffinic component comprise, consist essentially of or consist of n-paraffins; and at least a portion of the paraffins having lower carbon numbers comprise, consist essentially of or consist of n-paraffins. In certain embodiments: at least a portion of the paraffins in the heavy paraffinic component comprise, consist essentially of or consist of n-paraffins; and at least a major amount, a significant amount or a substantial amount of the paraffins having lower carbon numbers comprise, consist essentially of or consist of n-paraffins.

In certain embodiments in which the encapsulating material comprises, consists essentially of or consists of a mixture containing the one or more heavy C31-C50 paraffins as a heavy paraffinic component, and a light paraffinic component including one or more paraffins having lower carbon numbers, the lowest melting point is greater than the expected temperature of the environment until the atmosphere is acceptable for the coating material to be melted, for example, greater than about 40, 45 or 50° C., in certain embodiments about 40-95, 40-90, 40-85, 45-95, 45-90, 45-85, 50-95, 50-90 or 50-85° C. This environment includes, for example, outside air temperatures if the encapsulated catalyst-containing structure having spent or contaminated catalyst therein is exposed to such temperatures, which may, for example, reach as high as about 50° C. In embodiments in which temperatures can be controlled in the environment for storage, transport and handling of the encapsulated catalyst-containing structure having spent or contaminated catalyst therein (e.g., indoor climate controlled such as about 18-25 or 20-25° C.), lower melting point paraffins may be effective for one or more light paraffin components consistent with the expected environment, such as C16, C17 and/or C18 paraffins. In embodiments in which temperatures can be refrigerated in the environment for storage, transport and handling of the encapsulated catalyst-containing structure having spent or contaminated catalyst therein (e.g., such as about 0-15° C.), even lower melting point paraffins may be effective for one or more light paraffin components consistent with the expected environment.

In certain implementations, a liquified encapsulating material is provided as a solution with a solvent. In certain embodiments, the selected paraffin or paraffin composition forming the coating material is dissolved in a suitable solvent or combination of solvents. In certain embodiments selected paraffin or paraffin composition forming the coating material is partially dissolved providing a two-phase system. If the solid paraffin is to dissolve in the liquid solvent, there will initially be a mixed phase until the paraffin has dissolved; temperature, time and stirring speed (or agitation) will dictate the speed at which the two-phase solid/liquid becomes a single liquid phase. The solvent(s) are effective for dissolving the encapsulating material and is/are also removable to form a solid phase of the encapsulating material. A liquified encapsulating material is provided as a solution con contain any suitable quantity of encapsulating material, for instance 0.1-99, 0.1-90, 0.1-80, 0.1-70, 0.1-60, 0.1-50, 0.1-25, 0.1-10, 0.1-5, 1-99, 1-90, 1-80, 1-70, 1-60, 1-50, 1-25, 1-10, 1-5, 5-99, 5-90, 5-80, 5-70, 5-60, 5-50, 5-25 or 5-10 mass percent of the encapsulating material relative to the mass of the solution including the solvent(s). hexane

In embodiments using heavy paraffin encapsulating materials, a solvent can be used to prepare the encapsulating material by forming into a liquid phase as a liquified coating material solution. For example, such solvents include light paraffinic or aromatic solvents (preferably contaminant free to maintain integrity of the spent and/or contaminated catalyst), and have a carbon number in the range of 5-7, instance including one or more of pentane, hexane, benzene, toluene, or a mixture thereof. In certain embodiments a naphtha or light naphtha fraction (preferably hydrotreated), for example boiling in the range of about 36-100, 36-90, 36-80, 36-70 or 36-60° C., can be used. Solvent is removed by heating to a temperature above the solvent boiling point and below the encapsulating material melting point.

In general, under a nitrogen atmosphere, a receptacle is introduced into the reactor having the catalyst-containing structure, for example, via the reactor head space through a designated manway at the top of the reactor, positioned under the catalyst-containing structure. The receptacle may contain, and/or be filled with, liquified encapsulating material or liquified encapsulating material solution, in an amount sufficient to submerge or partially submerge the catalyst-containing structure having spent or contaminated catalyst therein; in certain embodiments if additional coverage is needed, additional liquified encapsulating material can be applied by another method such as by pouring and/or spraying. The liquified encapsulating material or liquified encapsulating material solution is solidified. In certain embodiments, the liquified encapsulating material or liquified encapsulating material solution is solidified after the receptacle is removed from the reactor. In certain embodiments, the liquified encapsulating material or liquified encapsulating material solution is solidified in the reactor. The receptacle with the encapsulated catalyst-containing structure having spent or contaminated catalyst therein can be safely transported, for example, to a testing facility, while minimizing or eliminating risk of exothermic autothermal reactions and environmental contamination.

In additional embodiments, the encapsulated catalyst-containing structure having spent or contaminated catalyst therein is transported to a suitable environment to handle the contaminated catalyst-containing structure, for example for testing the catalysts. The solidified encapsulating material is removed. In certain embodiments, removal of the solidified encapsulating material includes mechanically removing all or a portion thereof (which may be reused as encapsulating material for another catalyst-containing structure). In certain embodiments, removal of the solidified encapsulating material includes heating to melt the encapsulating material, for example, by heating in a suitable vessel or tub to melt the encapsulating material for partial or complete removal (where the removed encapsulating material may be reused as encapsulating material for another catalyst-containing structure.

Referring to FIG. 5, removal of a catalyst-containing structure having spent or contaminated catalyst therein is schematically shown. A catalyst-containing structure 552 containing spent and/or contaminated catalyst particles 554 is located in a reactor 580. The catalyst particles 554 are spent and/or contaminated, as indicated in FIG. 5 by darkened particles.

In an embodiment of a method to remove the catalyst-containing structure 552 while minimizing or eliminating exposure to contaminants and/or risk of exothermic autothermal reactions, a head space of reactor 580 is accessed while the reactor is under a nitrogen blanket 590. For example, while is the reactor under the nitrogen blanket, the reactor is accessed from a designated manway (typically located in the top of the reactor), and the catalyst-containing structure is located while unloading the spent principal catalyst. A receptacle 556 introduced in the reactor 580. The receptacle 556 is positioned under the catalyst-containing structure 552. In certain implementations, the catalyst-containing structure 552 is attached to a receptacle retrieval line 560. The receptacle 556 is dimensioned and configured to hold the catalyst-containing structure and an effective amount of encapsulation material to fully encapsulate the catalyst-containing structure, for example, having an area suitable to fit the catalyst-containing structure and a height extending above that of the catalyst-containing structure. The receptacle 556 may contain, and/or be filled with encapsulating material 558. The encapsulating material 558 may be a liquified encapsulating material (e.g., similar to a liquefied coating material described herein) or a liquified encapsulating material solution (e.g., similar to a liquefied coating material solution described herein). In certain embodiments, an amount of encapsulating material 558 is provided that is sufficient to submerge the catalyst-containing structure having spent or contaminated catalyst therein. In certain embodiments, an amount of encapsulating material 558 is provided that is sufficient to partially submerge the catalyst-containing structure having spent or contaminated catalyst therein; thereafter whilst under the nitrogen blanket, an additional amount of encapsulating material 558 is added.

The liquified encapsulating material or liquified encapsulating material solution is provided in a loaded receptacle 562. The loaded receptacle 562 includes the catalyst-containing structure 552 containing spent and/or contaminated catalyst particles 554, which is encapsulated by the receptacle 556 and the encapsulating material 558 to prevent air and/or water to access the catalyst particles therein. In certain embodiments, a receptacle lid 564 is added to the loaded receptacle 562 to provide a capped and loaded receptacle 566.

In certain embodiments, solidification is carried out to an extent so as to provide entirely solid encapsulating material around the catalyst-containing structure 552 containing spent and/or contaminated catalyst particles 554. Optionally, in embodiments in which entirely solid encapsulating material is formed around the catalyst-containing structure 552 containing spent and/or contaminated catalyst particles 554, the encapsulated catalyst-containing structure can be released from the receptacle and safely transported due to the solid encapsulating material minimizing or preventing ingress of air and/or moisture from the outside environment, and also minimizing or preventing egress of contaminants to the outside environment from spent and/or contaminated catalyst particles.

In certain embodiments, solidification is only partially carried out, or not carried out until a later stage, and catalyst-containing structure may be safely transported. For example, the catalyst-containing structure may be submerged in liquid, or mixed liquid and solid; the receptacle having the submerged catalyst-containing structure with spent and/or contaminated catalyst particles may be safely transported, due to the submersion in the liquid or liquid/solid encapsulating material, ingress of air and/or moisture from the outside environment, and egress of contaminants to the outside environment from spent and/or contaminated catalyst particles, is minimized or prevented. In certain embodiments, partial solidification, additional partial solidification, or complete solidification occurs outside of the reactor when the conditions for solidification are met, e.g., below the melting point of encapsulating material, and/or effective to remove any solvent used. In certain embodiments, partial solidification, additional partial solidification, or complete solidification occurs during transportation when the conditions for solidification are met, e.g., below the melting point of encapsulating material, and/or effective to remove any solvent used. In such embodiments in which the catalyst-containing structure with spent and/or contaminated catalyst particles is submerged in liquid or liquid/solid encapsulating material prior to or during transport, the entire receptacle is transported to maintain safe handling.

In certain embodiments, both solidification or partial solidification, and installation of the lid, occur within the reactor and whilst under nitrogen blanket; the capped and loaded receptacle 566 is removed from the reactor. In certain embodiments, solidification or partial solidification occurs within the reactor and whilst under nitrogen blanket; the loaded receptacle 562 that has been solidified is removed from the reactor; and installation of the lid occurs outside of the reactor to provide the capped and loaded receptacle 566. In certain embodiments, the loaded receptacle 562 that has not yet been solidified or partial solidified is removed from the reactor, and both solidification or partial solidification, and installation of the lid, occur outside of the reactor to provide the capped and loaded receptacle 566.

Solidifying, within or outside of the reactor (as a separate step or together with transport), may be carried out by cooling and/or evaporation, depending on the composition of the encapsulating material. In embodiments in which encapsulating material is provided as a melted liquified encapsulating material, solidifying the encapsulating material in the receptacle comprises exposing the receptacle with the catalyst-containing structure including spent and/or contaminated catalyst particles having liquified encapsulating material to temperatures below the melting point of the encapsulating material. In certain embodiments solidifying comprises exposing the receptacle with the catalyst-containing structure having liquified coating material to ambient temperatures (e.g., a temperature in the range of about 20° C. to about 25° C.). In certain embodiments solidifying comprises exposing the receptacle with the catalyst-containing structure including spent and/or contaminated catalyst particles having liquified encapsulating material to temperatures lower than ambient, for example, a temperature in the range of about −20° C. to about 20° C., −20° C. to about 15° C., −20° C. to about 10° C. or −20° C. to about 0° C., to increase the rate of solidification.

In embodiments in encapsulating material is provided an encapsulating material solution or suspension, solidifying or partial solidifying of the encapsulating material comprises evaporation of the solvent used for the solution liquified coating material solution. For example, in embodiments in which the selected paraffin(s) is/are dissolved in the solvent, when the solvent is evaporating the paraffin will precipitate and solidify around the catalyst-containing structure within the receptacle and whilst under nitrogen blanket.

The contained catalyst (for example catalyst contained in the interior volume 104, 204 or 304 herein) within the removable catalyst-containing structure (for example catalyst-containing structure 102, 202 or 302 herein) can be a hydroprocessing catalyst that is suitable for, or postulated to be suitable for hydroprocessing. In certain embodiments the catalyst used in a reactor (for example reactor-contained catalyst 482 herein) can be a fresh hydroprocessing catalyst that is suitable for hydroprocessing, and the catalyst within the catalyst-containing structure may be the same or different, depending for instance on the nature and purpose of the testing. Structurally, hydroprocessing catalysts generally comprise a porous support and at least one metal supported on the porous support. In certain implementations the contained catalyst has functionality for one or more types of hydroprocessing reactions selected from the group consisting of hydrodesulfurization, hydrodenitrogenation, hydrodemetallization, hydrocracking, hydrogenation, hydroisomerization, and combinations of two or more of the foregoing reactions. The functionality can be tailored by the type and ratios of and support material, type and amount of metal(s), and by other structural and chemical variations. The catalyst within the catalyst-containing structure can include yet-to-be developed catalysts since one application of the encapsulated catalyst-containing structure is for testing the performance thereof.

In one or more embodiments the porous support may include alumina (A1₂O₃), silica (SiO₂), titania (TiO₂), zeolite, or combinations thereof. In one or more embodiments, the porous support may include a zeolite. As used herein, a “zeolite” refers to a microporous, crystallized aluminosilicate material. Zeolites used in hydroprocessing catalysts include but are not limited to a FAU, MFI, MOR, or BEA type framework as defined by International Zeolite Association (IZA) Structure Commission. In one or more embodiments, the porous support may include alumina, silica, titania, or combinations thereof. The porous support may have a molar ratio of silica-to-alumina, for example from about 1-1000, 1-500, 1-300, 1-200, 1-100, 2-1000, 2-500, 2-300, 2-200, 2-100, 5-1000, 5-500, 5-300, 5-200, and 5-100.

In one or more embodiments, a porous support of a hydroprocessing catalysts includes active support materials such as a zeolite, and a binder material (which may be inactive or less active than the zeolite). Examples of binder materials include alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, and silica-alumina-zirconia. Active support materials include zeolitic materials, including but not limited to FAU, MFI, MOR, or BEA type framework zeolites (aluminosilicates and/or silicates). Active support materials include zeolitic materials with medium or large pore sizes. In certain embodiments active support materials include MOR, MFI (for example ZSM-5, ZSM-11, ZSM-12, ZSM-22, ZSM-23 or ZSM 35), or zeolites of type beta and Y, including USY

In embodiments in which the contained catalyst contains zeolite, such as hydroprocessing catalyst, they are hygroscopic and absorb water upon exposure to air. Water absorption results several disadvantages, for example, weight gain, activity loss, etc., for the catalyst. After loading in the reactor, the hydroprocessing catalysts are sulfided to convert active phase metals to sulfide form from oxide form. The hydroprocessing catalysts are also offered in pre-sulfided form by the catalyst manufacturers and the catalysts are often activated with hydrogen, but these are susceptible to reduced catalytic activity upon exposure to air.

In certain embodiments, the porous supports have a pore volume in the range of about (cc/gm) 0.15-1.70, 0.15-1.50, 0.15-1.25, 0.15-1.0, 0.15-0.75, 0.30-1.70, 0.30-1.50, 0.30-1.25, 0.3-1.0, 0.3-0.75, 0.40-1.70, 0.40-1.50, 0.40-1.25, 0.40-1.0, or 0.40-0.75. The pore volume of the porous support may be measured by Brunauer, Emmett, and Teller (“BET”) method, which measures the quantity of nitrogen adsorbed on the support. In certain embodiments, the porous support has a specific surface area in the range of about (m²/g) 100-1000, 100-900, 100-500, 100-450, 180-900, 180-500, 180-450, 200-900, 200-500 or 200-450. In certain embodiments, the porous supports have average pore size of about 10-10000, 50-10000, 100-10000, 10-9000, 50-9000, 100-9000, 10-8000, 50-8000, 100-8000, 10-5000, 50-5000 or 100-5000 angstrom units. The average pore sizes may be calculated by the equation Ps=4V/S, where Ps=pore size, V=pore volume, and S=surface area.

The porous supports may be formed into a shape selected from the group of sphere, cylinder, trilobe, twisted trilobe, and quadra-lobes. Methods for shaping the porous supports may include, for example, extrusion, spray drying, pelletizing, agglomeration, oil drop, and the like. As used herein, an “oil drop” process refers to when precipitation occurs upon the pouring of a liquid into an immiscible liquid.

The at least one metal, also referred to as active metal or active metal component(s), that are carried on the catalyst particles are metals or metal compounds (oxides or sulfides) selected from International Union of Pure and Applied Chemistry (IUPAC) Groups 6, 9 and 10 metals. In certain embodiments, the active metal component(s) is/are one or more of Mo, W, Co or Ni. In one embodiment, the at least one metal may be in oxide form, such as CoO, MoO₃, NiO, WO₃. In other embodiments, the at least one metal may be in sulfide form, such as Co₉S₈, MoS₂, Ni₃S₂, WS₂.

The active metal component(s) is/are typically deposited or otherwise incorporated on the particles. The active metal component(s) are incorporated in an effective concentration, for instance, in the range of (mass percent based on the mass of the oxides, sulfides or metals relative to the total mass of the catalysts) 1-40, 1-30, 1-10, 1-5, 2-40, 2-30, 2-10, 3-40, 3-30 or 3-10. In certain embodiments, alone or in combination with the above metals, Pt group metals such as Pt and/or Pd, may be present as a hydrogenation component, generally in an amount of about 0.1-2 mass percent based on the weight of the catalyst.

In certain embodiments, average cross-sectional dimension of particles or extrudates of the contained catalyst is about 1.0-5.0, 1.0-4.0, 1.0-3.0, 1.5-5.0, 1.5-4.0, 1.5-3.0, 2.0-5.0, 2.0-4.0 or 2.0-3.0 millimeters. In certain embodiments the contained catalyst are 1/16 inch catalyst extrudates (1.5875 millimeters diameter) or 1/inch catalyst extrudates (3.175 millimeters diameter). The cross-sectional dimension of the hydroprocessing catalyst may be measured using Transmission Electron Microscopy (TEM), dry sieving, or the laser light scattering technique.

The hydroprocessing catalysts may be bi-functional catalysts, having both a cracking function and a hydrogenation function. The cracking function may be provided by cracking components, such as zeolite, alumina, silica, titania, or combinations thereof. The hydrogenation function may be provided by the at least one metal including the IUPAC Groups 6, 9 and 10 metals. In some embodiments, the at least one metal may be added to the porous support by mixing or impregnation. For example, the IUPAC Groups 6, 9 and 10 metals may be introduced to the porous support by mixing, and may be converted to an oxide in-situ by calcination.

In certain embodiments, hydroprocessing catalysts include a catalyst activation agent, a catalyst deactivation agent, or both loaded onto pores of the porous support, the catalyst activation agent comprising at least one sulfur compound and the catalyst deactivation agent comprising at least one nitrogen compound. The catalyst activation agent, a catalyst deactivation agent, or both may be impregnated or absorbed into the pores of the porous support. The catalyst activation agent may include a sulfur containing compound. In one embodiment, the catalyst activation agent may include organic sulfide, organic disulfide, organic polysulfide, elemental sulfur, or their oxidized forms. For example, the catalyst activation agent may include methanethiol, thiophene, dialkyl disulfide, diaryl disulfide, or combinations thereof. The catalyst activation agent may include dimethyl disulfide (DMDS). The catalyst activation agent may include disulfide oil from a Mercaptan Oxidation (Merox) unit. The disulfide oil from the Merox unit may have a general formula R—S—S—R′, wherein R and R′ are alkyl groups with carbon number in the range 1 to 20. In some embodiments, the general formula may include DMDS. The catalyst deactivation agent may include a nitrogen containing compound. In one embodiment, the catalyst deactivation agent may include an organic nitrogen compound. For example, the catalyst deactivation agent may include amine, carbazole, indoles, quinoline, amide, acridine, aniline, ammonia, or their oxidized forms. The catalyst deactivation agent may include methyldiethanolamine (MDEA).

In certain implementations, the catalyst particles are calcined. In certain implementations, the catalyst particles are calcined and presulfided. After calcining and pre-sulfiding, the catalyst particles are free of or substantially free water (for example less than about 0.05 or 0.005 mass percent water relative to the mass of the catalyst particles).

The hydroprocessing catalyst may be used as catalysts for hydroprocessing reactions. Example hydrocarbon feedstocks that may be processed by the hydroprocessing catalysts presently described include crude oil fractions such as naphtha, diesel, vacuum gas oil, vacuum residue or intermediate refinery streams such as deasphalted oil, coker naphtha, gas oils, and fluid catalytic cracking cycle oils. In hydroprocessing reactions, the major reactions may be sulfur, nitrogen, and metal removal. The hydroprocessing catalysts may have one or more of hydrodesulfurization (HDS) functionality, hydrodenitrogenation (HDN) functionality, hydrodemetallization (HDM) functionality, hydrocracking (HCR) functionality, or hydrogenation (HYD) functionality.

As used in this disclosure, a “loaded hydroprocessing catalyst” refers to a catalyst including the hydroprocessing catalyst and the catalyst activation agent, the catalyst deactivation agent, or both onto pores of the hydroprocessing catalyst.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). To facilitate understanding, like reference numerals have been used, where possible, to designate like elements common to the figures. In certain instances, a letter suffix following a dash ( . . . -b) denotes a specific example of an element marked by a particular reference numeral (e.g., 210-b). Description of elements with references to the base reference numerals (e.g., 210) also refer to all specific examples with such letter suffixes (e.g., 210-b), and vice versa.

It is to be further understood that like or similar numerals in the drawings represent like or similar elements through the several figures, and that not all components or steps described and illustrated with reference to the figures are required for all embodiments or arrangements.

As used herein, “about” means within a margin of less than or equal to plus or minus 1, 2, 5 or 10% of the compared value. The term “major” with respect to a particular structure, structural feature, composition or stream means at least about 50% and up to about 90, 95, 99 or 100% of the defined structure, structural feature, composition or stream. The term “minor” with respect to a particular structure, structural feature, composition or stream means from about 0.1, 1 or 5% up to about 50% of the defined structure, structural feature, composition or stream. The term “significant” with respect to a particular structure, structural feature, composition or stream means at least about 75, 80 or 85% and up to about 90, 95, 99 or 100% of the defined structure, structural feature, composition or stream. The term “substantial” with respect to a particular structure, structural feature, composition or stream means at least about 90, 95 or 98% and up to about 99 or 100% of the defined structure, structural feature, composition or stream.

As used in this disclosure, a “catalyst” refers to any substance which increases the rate of a specific chemical reaction. In certain contexts, catalysts described in this disclosure include fresh catalyst. In certain contexts, catalysts described in this disclosure include spent catalyst and/or contaminated catalyst, as a result of reactions occurring on the surfaces and in the pores over a period of time. Catalysts described in this disclosure may be utilized to promote various reactions, such as, but not limited to hydroprocessing reactions. Hydroprocessing reactions include but are not limited to hydrocracking, hydrotreating, hydrodemetalization, hydrodesulfurization, hydrodenitrogenation, hydrogenation, or combinations thereof. As used in this disclosure, “cracking” generally refers to a chemical reaction where a molecule having carbon to carbon bonds is broken into more than one molecule by the breaking of one or more of the carbon to carbon bonds, or is converted from a compound which includes a cyclic moiety, such as an aromatic, to a compound which does not include a cyclic moiety. “Hydrocracking” refers to the cracking of hydrocarbons in the presence of hydrogen.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof, and are meant to encompass the items listed thereafter and equivalents thereof as well as additional items.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting.

While the disclosure has described several example implementations, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for carrying out this disclosure, but that the disclosure will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope encompassed by the present disclosure, which is defined by the set of recitations in the following claims and by structures and functions or steps which are equivalent to these recitations.

TABLE 1

| n-alkane Carbon | | Melting Point | Boiling Point |
|---|---|---|---|
| Number | IUPAC Name | (° C.) | (° C.) |
| 4 | n-butane | −138.2 | −0.5 |
| 5 | neopentane | −16.4 | 9.5 |
| 5 | n-pentane | −129.7 | 36.0 |
| 6 | n-hexane | −95.3 | 68.7 |
| 7 | n-heptane | −90.6 | 98.5 |
| 8 | n-octane | −56.8 | 125.6 |
| 9 | n-nonane | −53.5 | 150.8 |
| 10 | n-decane | −29.7 | 174.1 |
| 11 | n-undecane | −25.6 | 195.9 |
| 12 | n-dodecane | −9.6 | 216.3 |
| 13 | n-tridecane | −5.3 | 235.4 |
| 14 | n-tetradecane | 5.8 | 253.5 |
| 15 | n-pentadecane | 9.9 | 270.6 |
| 16 | n-hexadecane | 18.1 | 286.8 |
| 17 | n-heptadecane | 22.0 | 302.0 |
| 18 | n-octadecane | 28.2 | 316.3 |
| 19 | n-nonadecane | 32.1 | 329.9 |
| 20 | n-eicosane | 36.8 | 343.0 |
| 21 | n-heneicosane | 40.5 | 356.5 |
| 22 | n-docosane | 44.4 | 368.6 |
| 23 | n-tricosane | 47.6 | 380.0 |
| 24 | n-tetracosane | 54.0 | 391.3 |
| 25 | n-pentacosane | 54.0 | 401.9 |
| 26 | n-hexacosane | 56.4 | 412.2 |
| 27 | n-heptacosane | 59.5 | 442.0 |
| 28 | n-octacosane | 64.5 | 431.6 |
| 29 | n-nonacosane | 63.7 | 440.8 |
| 30 | n-triacontane | 65.8 | 449.7 |
| 31 | n-hentriacontane | 67.9 | 458.0 |
| 32 | n-dotriacontane | 69.7 | 467.0 |
| 33 | n-tritriacontane | 72.0 | 476.0 |
| 34 | n-tetratriacontane | 72.6 | 483.0 |
| 35 | n-pentatriacontane | 75.0 | 490.0 |
| 40 | n-tetracontane | 82.0 | 522.0 |
| 50 | n-pentacontane | 92.0 | 575.0 |
| 60 | n-hexacontane | 100.0 | 625.0 |

1. A method of removal of a catalyst-containing structure having spent or contaminated catalyst from a reactor comprising, while maintaining the reactor under a nitrogen blanket:
introducing a receptacle dimensioned and configured to hold the catalyst-containing structure for full submersion via a head space of the reactor and positioning said receptacle about the catalyst-containing structure, wherein:
the receptacle contains an amount of encapsulating material, in the form of a liquified encapsulating material or a liquified encapsulating material solution, that is sufficient to submerge the catalyst-containing structure, and the receptacle containing the catalyst-containing structure and the encapsulating material is removed as a loaded receptacle; or
the receptacle contains an amount of encapsulating material, in the form of a liquified encapsulating material or a liquified encapsulating material solution, that is less than sufficient to submerge the catalyst-containing structure, additional encapsulating material is added while the under the nitrogen blanket to submerge the catalyst-containing structure, and the receptacle containing the catalyst-containing structure and the encapsulating material is removed as a loaded receptacle.

2. The method as in claim 1, further comprising adding a lid to the loaded receptacle either within the reactor and while under the nitrogen blanket, or outside of the reactor.

3. The method of claim 1, further comprising solidifying the liquified encapsulating material or the liquified encapsulating material solution either within the reactor and while under the nitrogen blanket, or outside of the reactor.

4. The method of claim 1, further comprising solidifying the liquified encapsulating material or the liquified encapsulating material solution either within the reactor and while under the nitrogen blanket, or outside of the reactor, and removing from the receptacle an encapsulated catalyst-containing structure.

5. The method of claim 3, wherein the encapsulating material initially in the receptacle comprises liquified encapsulating material, and wherein solidifying comprises exposing the receptacle with the catalyst-containing structure including spent and/or contaminated catalyst particles having liquified encapsulating material to temperatures below the melting point of the encapsulating material.

6. The method of claim 3, wherein the encapsulating material initially in the receptacle comprises liquified encapsulating material, and wherein solidifying comprises exposing the receptacle with the catalyst-containing structure including spent and/or contaminated catalyst particles having liquified encapsulating material to a temperature in the range of about 20 to about 25° C.

7. The method of claim 3, wherein the encapsulating material initially in the receptacle comprises liquified encapsulating material, and wherein solidifying comprises exposing the receptacle with the catalyst-containing structure including spent and/or contaminated catalyst particles having liquified encapsulating material to a temperature in the range of about −20° C. to about 25° C.

8. The method of claim 3, wherein the encapsulating material initially in the receptacle comprises liquified encapsulating material solution comprising the encapsulating material and a solvent, and wherein solidifying comprises evaporation of the solvent.

9. The method of claim 1, wherein the encapsulating material comprises a C31-C50 paraffin.

10. The method of claim 1, wherein the encapsulating material comprises a mixture of two or more C31-C50 paraffins.

11. The method of claim 9, wherein at least a major amount of heavy paraffins comprise n-paraffins.

12. The method of claim 1, wherein the encapsulating material comprises a mixture containing one or more heavy paraffins including C31-C50 paraffins, and a light paraffinic component including one or more paraffins having lower carbon numbers.

13. The method of claim 12, wherein the light paraffinic component comprises one or more C15-C30, C16-C30, C17-C30, C18-C30 or C19-C30 paraffins.

14. The method of claim 12, wherein:
at least a portion of the paraffins in the heavy paraffinic component comprise n-paraffins, and at least a portion of the paraffins having lower carbon numbers comprise n-paraffins;
at least a major amount, a significant amount or a substantial amount of the paraffins in the heavy paraffinic component comprise n-paraffins, and at least a portion of the paraffins having lower carbon numbers comprise n-paraffins; or
at least a portion of the paraffins in the heavy paraffinic component comprise n-paraffins, and at least a major amount, a significant amount or a substantial amount of the paraffins having lower carbon numbers comprise n-paraffins.

15. A method of testing a catalyst in a reactor comprising:
inserting an encapsulated catalyst-containing structure in a reactor together with principal catalyst, the encapsulated catalyst-containing structure comprising a containment structure having catalyst particles contained within the catalyst-containing structure, the containment structure configured and dimensioned for insertion within a reactor and configured and dimensioned to fit in a minor volume of the reactor, the containment structure having external surfaces, wherein all or a portion of the external surfaces are permeable external surfaces having a plurality of openings permitting fluids to pass through while providing a barrier to retain catalyst particles, wherein the catalyst particles are dimensioned greater than a dimension of the openings, and wherein at least the permeable external surfaces are encapsulated in a coating material comprising heavy paraffins including C31-C50 paraffins;
removing the coating material from the encapsulated catalyst-containing structure;
flowing a reactant fluid in the reactor through the principal catalyst and through the catalyst-containing structure having the coating material removed and with the catalyst particles for testing contained within the catalyst-containing structure and exposed to reactant fluid flowing in the reactor; and
removing the catalyst-containing structure according to the method of claim 1.

16. A method of catalyzing a reactant fluid, the method comprising:
inserting an encapsulated catalyst-containing structure in a reactor together with principal catalyst, the encapsulated catalyst-containing structure comprising a containment structure having catalyst particles contained within the catalyst-containing structure, the containment structure configured and dimensioned for insertion within a reactor, the containment structure having external surfaces, wherein all or a portion of the external surfaces are permeable external surfaces having a plurality of openings permitting fluids to pass through while providing a barrier to retain catalyst particles, wherein the catalyst particles are dimensioned greater than a dimension of the openings, and wherein at least the permeable external surfaces are encapsulated in a coating material comprising heavy paraffins including C31-C50 paraffins;
removing the coating material from the encapsulated catalyst-containing structure;
flowing the reactant fluid in the reactor through the principal catalyst and through the catalyst-containing structure having the coating material removed and with the catalyst particles contained within the catalyst-containing structure; and
removing the catalyst-containing structure according to the method of claim 1.

17-47. (canceled)

48. The method of claim 4, wherein the encapsulating material initially in the receptacle comprises liquified encapsulating material, and wherein solidifying comprises exposing the receptacle with the catalyst-containing structure including spent and/or contaminated catalyst particles having liquified encapsulating material to temperatures below the melting point of the encapsulating material.

49. The method of claim 4, wherein the encapsulating material initially in the receptacle comprises liquified encapsulating material, and wherein solidifying comprises exposing the receptacle with the catalyst-containing structure including spent and/or contaminated catalyst particles having liquified encapsulating material to a temperature in the range of about 20 to about 25° C.

50. The method of claim 4, wherein the encapsulating material initially in the receptacle comprises liquified encapsulating material, and wherein solidifying comprises exposing the receptacle with the catalyst-containing structure including spent and/or contaminated catalyst particles having liquified encapsulating material to a temperature in the range of about −20° C. to about 25° C.

51. The method of claim 4, wherein the encapsulating material initially in the receptacle comprises liquified encapsulating material solution comprising the encapsulating material and a solvent, and wherein solidifying comprises evaporation of the solvent.
